(19) United States
(12) Patent Application Publication
(10) Pub. No.: US 2026/0227662 A1
(43) Pub. Date: Aug. 6, 2026

(54) LIQUID CRYSTAL ELEMENT AND HEAD-MOUNTED DISPLAY

(71) Applicant: Sharp Kabushiki Kaisha, Osaka (JP)

(72) Inventors: Daisuke MINAMI, Sakai City (JP); Hiroaki ASAGI, Sakai City (JP); Kiyoshi MINOURA, Sakai City (JP)

(21) Appl. No.: 19/529,648

(22) Filed: Feb. 4, 2026

(30) Foreign Application Priority Data
Feb. 6, 2025 (JP) 2025-018332

(51) Int. Cl. G02F 1/1343; G02F 1/13363; G02F 1/139

(52) U.S. Cl. CPC G02F 1/134309; G02F 1/13363; G02F 1/133634; G02F 1/1393

(57) ABSTRACT

A liquid crystal element includes: a first substrate, a first weak anchoring horizontal alignment film, a liquid crystal layer containing dual-frequency drive liquid crystal molecules, a second weak anchoring horizontal alignment film, and a second substrate in this order. The liquid crystal element further includes a retardation layer, a comb-teeth electrode is provided on at least one of the first substrate or the second substrate, the dual-frequency drive liquid crystal molecules are twist-aligned, an alignment direction of dual-frequency drive liquid crystal molecules located at a center of the liquid crystal layer in a thickness direction is perpendicular or parallel to an extension direction of the comb-teeth electrode, the retardation layer includes a first quarter-wavelength film and a second quarter-wavelength film, and at least one of the first quarter-wavelength film or the second quarter-wavelength film is a positive A plate or a negative A plate.

### CROSS-REFERENCE TO RELATED APPLICATIONS

This application claims the benefit of priority to Japanese Patent Application Number 2025-018332 filed on Feb. 6, 2025. The entire contents of the above-identified application are hereby incorporated by reference.

### BACKGROUND

### Technical Field

The following disclosure relates to a liquid crystal element and a head-mounted display.

In recent years, a varifocal optical system has been proposed for a head-mounted display or the like, the varifocal optical system being configured such that a Pancharatnam Berry (PB) lens and a liquid crystal element such as a switchable half wave plate (sHWP) are combined. The sHWP is a device capable of switching the polarization state of right and left handed circularly-polarized light, and is implemented by a liquid crystal.

As a technique related to a varifocal optical system, for example, JP 2021-501361 T discloses a display device including a waveguide and a broadband adaptive lens assembly, and a specification of U.S. Pat. No. 10,379,419 discloses a varifocal block including an sHWP and a plurality of liquid crystal lenses. JP 2023-082644 A and JP 2023-121716 A disclose an optical element capable of switching between polarization modulation and polarization non-modulation in a wide band and at a wide viewing angle.

### SUMMARY

However, it is difficult to implement a device structure capable of switching, in a wide band and at a wide viewing angle, between polarization modulation in which polarization states of right and left handed circularly-polarized light beams are converted and polarization non-modulation in which polarization states of right and left handed circularly-polarized light beams are not converted by the techniques of JP 2021-501361 T and the specification of U.S. patent Ser. No. 10/379,419. In addition, the optical elements disclosed in JP 2023-082644 A and JP 2023-121716 A are useful, but there is room for improvement in order to further improve alignment stability and to further achieve reductions in thickness and weight.

The disclosure has been made in view of the above circumstances, and an object thereof is to provide a liquid crystal element and a head-mounted display which are capable of switching between polarization modulation and polarization non-modulation in a wide band and at a wide viewing angle and have excellent alignment stability.
(1) An embodiment of the disclosure is a liquid crystal element including a first substrate, a first weak anchoring horizontal alignment film, a liquid crystal layer containing dual-frequency drive liquid crystal molecules, a second weak anchoring horizontal alignment film, and a second substrate in this order, in which the liquid crystal element further includes a retardation layer on at least one of a side of the first substrate opposite to the liquid crystal layer or a side of the second substrate opposite to the liquid crystal layer, a comb-teeth electrode configured to generate an electric field for the liquid crystal layer is provided on at least one of the first substrate or the second substrate, the dual-frequency drive liquid crystal molecules are twist-aligned between the first substrate and the second substrate in a voltage applied state and a voltage non-applied state, and a twist direction in the voltage applied state is identical to a twist direction in the voltage non-applied state, an alignment direction of dual-frequency drive liquid crystal molecules located at a center of the liquid crystal layer in a thickness direction is perpendicular or parallel to an extension direction of the comb-teeth electrode, the retardation layer includes a first quarter-wavelength film and a second quarter-wavelength film in this order from a side closer to the liquid crystal layer, and at least one of the first quarter-wavelength film or the second quarter-wavelength film is a positive A plate or a negative A plate.
(2) Furthermore, an embodiment of the disclosure is the liquid crystal element including a configuration in which, in addition to the above configuration of (1), any one of (i) to (iv) described below is satisfied:
(i) the first quarter-wavelength film and the second quarter-wavelength film are positive A plates;
(ii) the first quarter-wavelength film is a positive A plate, the second quarter-wavelength film is a negative A plate, and the liquid crystal element further includes a retardation film other than the first quarter-wavelength film and the second quarter-wavelength film;
(iii) the first quarter-wavelength film is a negative A plate, and the second quarter-wavelength film is a positive A plate; and
(iv) the first quarter-wavelength film and the second quarter-wavelength film are negative A plates.
(3) Furthermore, an embodiment of the disclosure is the liquid crystal element including a configuration in which, in addition to the above configuration of (1) or (2), the first quarter-wavelength film and the second quarter-wavelength film are disposed on a side of the second substrate opposite to the liquid crystal layer.
(4) Furthermore, an embodiment of the disclosure is the liquid crystal element including, in addition to the above configuration of (1), (2), or (3), a positive C plate on a side of the first substrate opposite to the liquid crystal layer.
(5) Furthermore, an embodiment of the disclosure is the liquid crystal element including a configuration in which, in addition to the above configuration of (1), (2), (3), or (4), the first weak anchoring horizontal alignment film has an azimuthal anchoring energy of less than 1×10⁻⁴ J/m².
(6) Furthermore, an embodiment of the disclosure is the liquid crystal element including a configuration in which, in addition to the above configuration of (1), (2), (3), (4), or (5), the first weak anchoring horizontal alignment film contains a polymer including at least one group of a group represented by the following structural formula (P1) or a group represented by the following structural formula (P2):

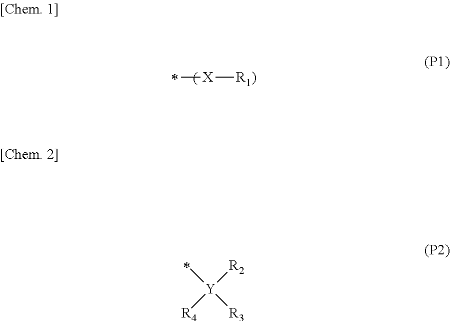

in the above structural formulae, X represents at least one group of an ether group, an ester group, or an amide group; R₁, R₂, R₃, and R₄ each independently represent a hydrocarbon group; and Y represents a carbon atom or a silicon atom.
(7) Furthermore, an embodiment of the disclosure is the liquid crystal element including a configuration in which, in addition to the above configuration of (1), (2), (3), (4), (5), or (6), the second weak anchoring horizontal alignment film has an azimuthal anchoring energy of less than 1×10⁻⁴ J/m².
(8) Furthermore, an embodiment of the disclosure is the liquid crystal element including a configuration in which, in addition to the above configuration of (1), (2), (3), (4), (5), (6), or (7), the second weak anchoring horizontal alignment film contains a polymer including at least one group of a group represented by the following structural formula (P1) or a group represented by the following structural formula (P2):

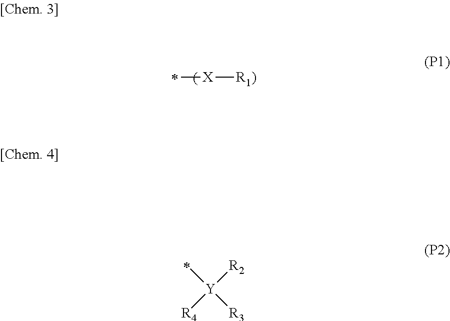

in the above structural formulae, X represents at least one group of an ether group, an ester group, or an amide group; R₁, R₂, R₃, and R₄ each independently represent a hydrocarbon group; and Y represents a carbon atom or a silicon atom.
(9) Furthermore, an embodiment of the disclosure is the liquid crystal element including a configuration in which, in addition to the above configuration of (1), (2), (3), (4), (5), (6), (7), or (8), the first weak anchoring horizontal alignment film and the second weak anchoring horizontal alignment film do not have a uniaxial orientation.
(10) Furthermore, an embodiment of the disclosure is the liquid crystal element including a configuration in which, in addition to the above configuration of (1), (2), (3), (4), (5), (6), (7), (8), or (9), the first weak anchoring horizontal alignment film and the second weak anchoring horizontal alignment film each have an in-plane retardation of less than 1 nm.
(11) Furthermore, an embodiment of the disclosure is the liquid crystal element including a configuration in which, in addition to the above configuration of (1), (2), (3), (4), (5), (6), (7), (8), (9), or (10), in the voltage non-applied state, the alignment direction of the dual-frequency drive liquid crystal molecules located at the center of the liquid crystal layer in the thickness direction is perpendicular to the extension direction of the comb-teeth electrode.
(12) Furthermore, an embodiment of the disclosure is the liquid crystal element including a configuration in which, in addition to the above configuration of (1), (2), (3), (4), (5), (6), (7), (8), (9), (10), or (11), the comb-teeth electrode is provided on only one of the first substrate and the second substrate.
(13) Furthermore, an embodiment of the disclosure is the liquid crystal element including a configuration in which, in addition to the above configuration of (1), (2), (3), (4), (5), (6), (7), (8), (9), (10), (11), or (12), the comb-teeth electrode includes a first substrate side comb-teeth electrode provided on the first substrate and a second substrate side comb-teeth electrode provided on the second substrate, and an extension direction of the first substrate side comb-teeth electrode is parallel to an extension direction of the second substrate side comb-teeth electrode.
(14) Furthermore, an embodiment of the disclosure is the liquid crystal element including a configuration in which, in addition to the above configuration of (1), (2), (3), (4), (5), (6), (7), (8), (9), (10), (11), (12), or (13), a ratio of an electrode width to a slit width of the comb-teeth electrode (electrode width:slit width) is from 1:2 to 1:6.
(15) Furthermore, an embodiment of the disclosure is the liquid crystal element including a configuration in which, in addition to the above configuration of (1), (2), (3), (4), (5), (6), (7), (8), (9), (10), (11), (12), (13), or (14), a ratio of a thickness of the liquid crystal layer to a slit width of the comb-teeth electrode (thickness of liquid crystal layer:slit width) is from 1:2.5 to 1:10.
(16) Furthermore, an embodiment of the disclosure is the liquid crystal element including a configuration in which, in addition to the above configuration of (1), (2), (3), (4), (5), (6), (7), (8), (9), (10), (11), (12), (13), (14), or (15), at least one horizontal alignment film out of the first weak anchoring horizontal alignment film and the second weak anchoring horizontal alignment film is in contact with the comb-teeth electrode and contains at least two types of polymers having mutually different refractive indices, and a polymer having a smallest refractive index out of the at least two types of polymers is in contact with the liquid crystal layer.
(17) Furthermore, another embodiment of the disclosure is the liquid crystal element including a configuration in which, in addition to the above configuration of (1), (2), (3), (4), (5), (6), (7), (8), (9), (10), (11), (12), (13), (14), (15), or (16), a ratio of an azimuthal anchoring energy of the second weak anchoring horizontal alignment film to an azimuthal anchoring energy of the first weak anchoring horizontal alignment film is 10 or less.
(18) Furthermore, another embodiment of the disclosure is the liquid crystal element including a configuration in which, in addition to the above configuration of (1), (2), (3), (4), (5), (6), (7), (8), (9), (10), (11), (12), (13), (14), (15), (16), or (17), the first substrate or the second substrate further includes a flexible printed circuit board having a curved shape, and the comb-teeth electrode is provided only on a substrate, out of the first substrate and the second substrate, located in a curving direction of the flexible printed circuit board.
(19) Furthermore, another embodiment of the disclosure is a head-mounted display including the liquid crystal element according to (1), (2), (3), (4), (5), (6), (7), (8), (9), (10), (11), (12), (13), (14), (15), (16), (17), or (18) described above.

According to the disclosure, it is possible to provide a liquid crystal element and a head-mounted display which are capable of switching between polarization modulation and polarization non-modulation in a wide band and at a wide viewing angle and have excellent alignment stability.

### BRIEF DESCRIPTION OF DRAWINGS

The disclosure will be described with reference to the accompanying drawings, wherein like numbers reference like elements.

FIG. 1 is a schematic cross-sectional view of a liquid crystal element 10.

FIG. 2 is a schematic perspective view of the liquid crystal element 10.

FIG. 3 is a schematic diagram illustrating the alignment of liquid crystal molecules in a first state and a second state of the liquid crystal element 10.

FIG. 4 is a diagram illustrating the axial orientation of the liquid crystal element 10.

FIG. 5 is a schematic cross-sectional view illustrating an example of a weak anchoring alignment film included in the liquid crystal element 10.

FIG. 6 is a diagram illustrating Stokes plots of respective layers in the first state of the liquid crystal element 10.

FIG. 7 is a schematic cross-sectional view specifically illustrating an example of a layer configuration of the liquid crystal element 10.

FIG. 8 is a schematic cross-sectional view specifically illustrating an example of the layer configuration of the liquid crystal element 10.

FIG. 9 is a schematic cross-sectional view specifically illustrating an example of the layer configuration of the liquid crystal element 10.

FIG. 10 is a schematic cross-sectional view specifically illustrating an example of the layer configuration of the liquid crystal element 10.

FIG. 11 is a schematic cross-sectional view specifically illustrating an example of the layer configuration of the liquid crystal element 10.

FIG. 12 is a schematic cross-sectional view specifically illustrating an example of the layer configuration of the liquid crystal element 10.

FIG. 13 is a schematic cross-sectional view specifically illustrating an example of the layer configuration of the liquid crystal element 10.

FIG. 14 is a schematic cross-sectional view specifically illustrating an example of the layer configuration of the liquid crystal element 10.

FIG. 15 is a schematic perspective view of a liquid crystal element 10 according to Modification Example 1.

FIG. 16 is a schematic cross-sectional view of the liquid crystal element 10 according to Modification Example 1.

FIG. 17 is a schematic cross-sectional view of a variable focus element including electrodes only on an incident-side substrate.

FIG. 18 is a schematic perspective view of a liquid crystal element 10 according to Modification Example 2.

FIG. 19 is a graph conceptually showing a liquid crystal alignment azimuth with respect to the thickness direction of a liquid crystal layer 300 in a liquid crystal element 10 according to a first embodiment.

FIG. 20 is a graph conceptually showing a liquid crystal alignment azimuth with respect to the thickness direction of a liquid crystal layer 300 in the liquid crystal element 10 according to Modification Example 2.

FIG. 21 is a schematic cross-sectional view of a variable focus element 30 according to a fifth embodiment.

FIG. 22 is a schematic cross-sectional view of a variable focus element 30 according to Modification Example 3.

FIG. 23 is a schematic diagram illustrating an example of a head-mounted display 1.

FIG. 24 is a schematic diagram illustrating the alignment of liquid crystal molecules when a liquid crystal cell included in a liquid crystal element 10 obtained in Test Example 1 is heated to an isotropic phase state and then rapidly cooled.

FIG. 25 is a schematic diagram illustrating the alignment of liquid crystal molecules in a first state and a second state of the liquid crystal element 10 obtained in Test Example 1.

FIG. 26 is a diagram illustrating the axial orientation of the liquid crystal element 10 obtained in Test Example 1.

FIG. 27 is a diagram illustrating each layer configuration and each Worst |S3| of the liquid crystal element 10 obtained in Test Example 1.

FIG. 28 is a graph showing results of evaluation of S3 characteristics of a liquid crystal element L1 with respect to an azimuth angle at a polar angle of 30°.

FIG. 29 is a conceptual diagram illustrating setting of an azimuth.

### DESCRIPTION OF EMBODIMENTS

### Definition of Terms

In this specification, the term “azimuth” means a direction when a target direction is projected onto a substrate surface on an emission side of a liquid crystal element, and is expressed as an angle (azimuth angle) between the target direction and a reference azimuth. Here, the reference azimuth (0°) is set to be a direction when an alignment direction of liquid crystal molecules on a first substrate side in a first state is projected onto the substrate surface on the emission side of the liquid crystal element. That is, the azimuth angle in the alignment direction of the liquid crystal molecules on the first substrate side in the first state is set to 0°. The azimuth angle counterclockwise from the reference azimuth is a positive angle and the azimuth angle clockwise from the reference azimuth is a negative angle. The counterclockwise and clockwise directions both represent the rotation direction when the liquid crystal element is viewed from the emission side. In addition, the azimuth angle represents a value measured when the liquid crystal element is viewed in a plan view from the emission side.

Two straight lines (including axes, directions, and azimuths) that are perpendicular to each other mean that they are perpendicular to each other when the liquid crystal element is viewed in a plan view from the emission side. In addition, the expression “one of the two straight lines is provided obliquely with respect to the other straight line” means that the one straight line is provided obliquely with respect to the other straight line in a state where the liquid crystal element is viewed in a plan view from the emission side. In addition, an angle formed by the two straight lines means an angle formed by the one straight line and the other straight line in a state where the liquid crystal element is viewed in a plan view from the emission side.

Furthermore, the expression “two straight lines (including axes, directions, and azimuths) are perpendicular to each other” means that an angle between the two straight lines is 90°±5°, preferably 90°±1°, more preferably 90±0.5°, and particularly preferably 90° (completely perpendicular). The expression “two straight lines are parallel to each other” means that an angle between the two straight lines is 0°±3°, preferably 0°±1°, more preferably 0°±0.5°, and particularly preferably 0° (completely parallel).

A retardation film refers to a film in which at least one of an in-plane retardation (Re) or a thickness direction retardation (Rth) has a value of 10 nm or more, and preferably a film in which it has a value of 20 nm or more. In this specification, numerical values denoted by Re and Rth are absolute values.

The in-plane retardation (Re) is obtained by Re=(nx−ny)×d, where d (nm) is the thickness of a layer (film). In this specification, the term “retardation” refers to an in-plane retardation unless otherwise specified.

The thickness direction retardation (Rth) is obtained by the formula Rth=(nz−(nx+ny)/2)×d, where d (nm) is the thickness of a layer (film). In this specification, the retardation in the thickness direction is also referred to as a “thickness retardation”.

nx is a refractive index in a direction in which the in-plane refractive index is maximized (that is, a slow axis direction). ny is a refractive index in a direction perpendicular to the slow axis in the plane. nz is a refractive index in the thickness direction.

A measurement temperature and measurement wavelength for optical parameters such as a refractive index and a retardation are 23° C. and 550 nm, respectively, unless otherwise specified.

A quarter-wavelength film is also referred to as a λ/4 wavelength film, and refers to a retardation film that imparts an in-plane retardation of a quarter-wavelength to incident light having a wavelength A.

A positive A plate is a retardation film that satisfies nx>ny−nz. The symbol “=” includes not only a case where both are completely identical to each other but also a case where both are substantially identical to each other. To be specific, the expression “ny−nz” also includes a case where [(ny−nz)×d] is −10 nm or more and 10 nm or less.

The positive C plate is a retardation film that satisfies nz>nx−ny. The expression “nx−ny” also includes, for example, a case where [(nx−ny)×d] is 0 nm or more and 10 nm or less.

A negative A plate is a retardation film that satisfies ny<nx−nz. The expression “nx−nz” also includes, for example, a case where [(nx−nz)×d] is −10 nm or more and 10 nm or less.

The negative C plate is a retardation film that satisfies nz<nx−ny. The expression “nx−ny” also includes, for example, a case where [(nx−ny)×d] is 0 nm or more and 10 nm or less.

A “voltage applied state” means a voltage applied state in which a voltage equal to or higher than a threshold value is applied between a pair of common electrodes and a pixel electrode, and is also referred to as “at the time of voltage application”. A “voltage non-applied state” means a voltage non-applied state in which no voltage is applied between the pair of common electrodes and the pixel electrode (including a case where a voltage lower than a threshold value is applied), and is also referred to as “at the time of no voltage application”.

An embodiment of the disclosure will be described below. The disclosure is not limited to the contents described in the following embodiments, and appropriate design changes can be made within the scope that satisfies the configuration according to the disclosure. In the following description, the same reference numerals are appropriately used in common among the different drawings for the same parts or parts having similar functions, and repeated description thereof will be omitted as appropriate. The aspects of the disclosure may be combined as appropriate within the range that does not depart from the gist of the disclosure.

### First Embodiment

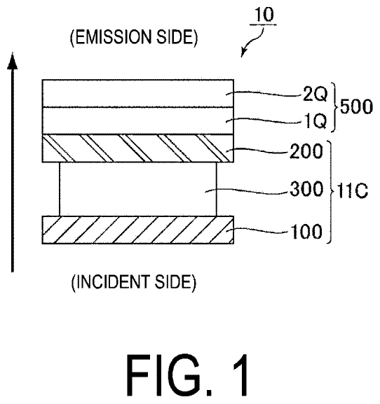

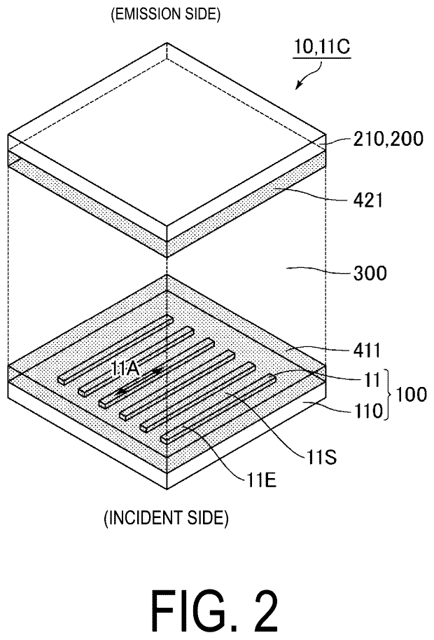

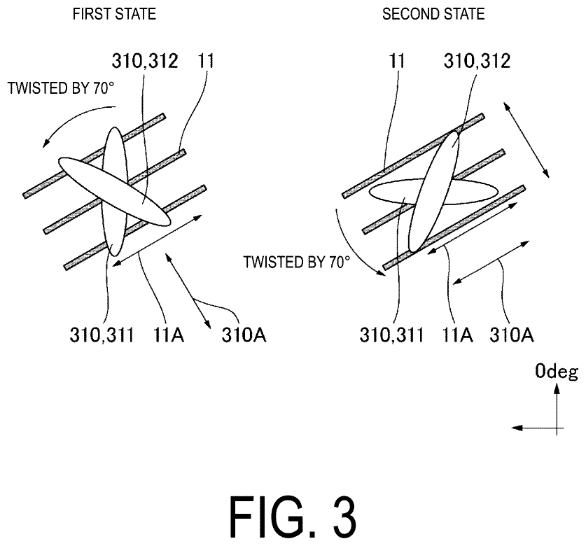

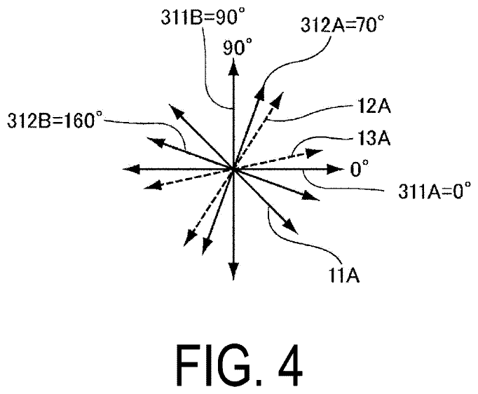

FIG. 1 is a schematic cross-sectional view of a liquid crystal element 10 according to the present embodiment. FIG. 2 is a schematic perspective view of the liquid crystal element 10 according to the present embodiment. FIG. 3 is a schematic diagram illustrating the alignment of liquid crystal molecules in a first state and a second state in the liquid crystal element 10 according to the present embodiment. FIG. 4 is a diagram illustrating the axial orientation of the liquid crystal element 10 according to the present embodiment.

As illustrated in FIGS. 1 to 4, the liquid crystal element 10 includes a first substrate 100, a first weak anchoring horizontal alignment film 411, a liquid crystal layer 300 containing dual-frequency drive liquid crystal molecules 310, a second weak anchoring horizontal alignment film 421, and a second substrate 200 in this order. The liquid crystal element 10 further includes a retardation layer 500 on at least one of the side of the first substrate 100 opposite to the liquid crystal layer 300 or the side of the second substrate 200 opposite to the liquid crystal layer 300. In addition, the liquid crystal element 10 includes comb-teeth electrodes 11 for generating an electric field (preferably, for generating a lateral electric field) in the liquid crystal layer 300 on at least one of the first substrate 100 or the second substrate 200. The dual-frequency drive liquid crystal molecules 310 are twist-aligned between the first substrate 100 and the second substrate 200 in a voltage applied state and a voltage non-applied state, and the twist direction in the voltage applied state and the twist direction in the voltage non-applied state are the same. The alignment direction of the dual-frequency drive liquid crystal molecules 310 located at the center of the liquid crystal layer 300 in the thickness direction is perpendicular or parallel to an extension direction 11A of the comb-teeth electrodes 11.

The liquid crystal element 10 of the present embodiment is a phase modulation element capable of switching between polarization modulation in which polarization states of right and left handed circularly-polarized light beams are converted and polarization non-modulation in which polarization states of right and left handed circularly-polarized light beams are not converted. Here, it is preferable that the phase modulation element have a high degree of circular polarization in both a modulation state and a non-modulation state. When a strong anchoring alignment film is disposed as an alignment film between the first substrate and the liquid crystal layer or between the second substrate and the liquid crystal layer, liquid crystal molecules are easily aligned along the strong anchoring alignment film, and thus initial alignment is stable. However, since the liquid crystal molecules are less likely to move due to an alignment restriction force of the strong anchoring alignment film, for example, the polarization modulation characteristics in the modulation state are good, but the polarization modulation characteristics in the non-modulation state may deteriorate. Depending on the design, the polarization modulation characteristics in the non-modulation state may be good, but the polarization modulation characteristics in the modulation state may deteriorate. That is, it is difficult to realize good polarization modulation characteristics in both the modulation state and the non-modulation state.

In order to solve this problem, for example, it is conceivable to use weak anchoring alignment films for both the first substrate and the second substrate, but the weak anchoring alignment films have a weak alignment restriction force, and thus it is generally difficult to improve alignment stability.

The inventors of the disclosure have considered that the effect of the comb-teeth electrodes provided on the substrate acts on the vicinity of a “substrate interface”, and thus have considered that the liquid crystal molecules located in the vicinity of the interface between the liquid crystal layer and each of the first substrate and the second substrate are preferably aligned parallel or perpendicular to the extension direction of the comb-teeth electrodes. However, the inventors of the disclosure have found that, in the case of the present embodiment in which weak anchoring alignment films are provided on both substrates, the effect of the comb-teeth electrodes can be exerted on the liquid crystal molecules located in the vicinity of the center (bulk) of the liquid crystal layer, not on the liquid crystal molecules located in the vicinity of the interface.

Consequently, in the present embodiment, a first weak anchoring horizontal alignment film 411 and a second weak anchoring horizontal alignment film 421 are respectively disposed between the first substrate 100 and the liquid crystal layer 300 and between the second substrate 200 and the liquid crystal layer 300, and they are disposed such that the alignment direction of the dual-frequency drive liquid crystal molecules 310 located at the center of the liquid crystal layer 300 in the thickness direction is perpendicular or parallel to the extension direction 11A of the comb-teeth electrodes 11 by using the dual-frequency drive liquid crystal molecules 310, thereby stabilizing the alignment of the dual-frequency drive liquid crystal molecules 310 (also referred to as bulk dual-frequency drive liquid crystal molecules 310) located in a region away from the interface between the first substrate 100 and the liquid crystal layer 300 and the interface between the second substrate 200 and the liquid crystal layer 300 and achieving good alignment stability. Thus, the liquid crystal element 10 according to the present embodiment can switch between polarization modulation and polarization non-modulation in a wide band and at a wide viewing angle, and has excellent alignment stability.

The liquid crystal element 10 of the present embodiment will be described in further detail below.

### Substrate

As illustrated in FIGS. 1 and 2, the first substrate 100 includes the first support substrate 110 and the comb-teeth electrodes 11 in this order toward the liquid crystal layer 300. The second substrate 200 includes a second support substrate 210 and does not include comb-teeth electrodes. A configuration including the members from the first substrate 100 to the second substrate 200 is also referred to as a liquid crystal cell 11C. That is, the first substrate 100, the first weak anchoring horizontal alignment film 411, the liquid crystal layer 300, the second weak anchoring horizontal alignment film 421, and the second substrate 200 configure the liquid crystal cell 11C.

The comb-teeth electrodes 11 are disposed to be switchable between a first state in which dual-frequency drive liquid crystal molecules 311 on the first substrate 100 side are aligned in a first alignment direction 311A and a second state in which the dual-frequency drive liquid crystal molecules 311 on the first substrate 100 side are aligned in a second alignment direction 311B perpendicular to the first alignment direction 311A in a plan view, by applying a voltage to the liquid crystal layer 300.

The comb-teeth electrode 11 has a structure in which linear electrode parts 11E and slit parts 11S are alternately and repeatedly disposed. The electrode width of the comb-teeth electrode 11 means the width of one linear electrode part 11E. The slit width of the comb-teeth electrode 11 means the width of one slit part 11S. The pitch of the comb-teeth electrode 11 means the total width of a pair including the linear electrode part 11E and the slit part 11S. The extension direction 11A of the comb-teeth electrode 11 means a direction in which the linear electrode part 11E extends. Here, the comb-teeth electrode includes a trunk electrode part extending in a first direction and a plurality of linear electrode parts extending from the trunk electrode part in a second direction different from the first direction. In FIGS. 1 to 4 and the like, the structure of the trunk electrode part of the comb-teeth electrode is omitted, and only the linear electrode part is shown.

In the present embodiment, an in-plane switching (IPS) electrode in which strip-shaped common electrodes and strip-shaped pixel electrodes are alternately arranged is used as the comb-teeth electrode 11, but the structure of the comb-teeth electrode 11 is not limited thereto. As the comb-teeth electrode 11, for example, a fringe field switching (FFS) electrode can also be suitably used. The FFS electrode includes, for example, a pixel electrode provided with a slit on a planar common electrode, with an insulating film interposed therebetween. The FFS electrode may also include a common electrode provided with a slit on a planar pixel electrode formed to occupy each pixel region, with an insulating film interposed therebetween. The comb-teeth electrode 11 of the present embodiment is preferably an IPS electrode. Thereby, the liquid crystal element 10 can improve transmittance and the degree of circular polarization.

The comb-teeth electrode 11 is provided on only one of the first substrate 100 and the second substrate 200. By adopting such an aspect, the liquid crystal element 10 can have a simpler configuration, and the productivity can be improved. In addition, when the comb-teeth electrodes 11 are disposed on both the first substrate 100 and the second substrate 200, moire is likely to occur, but in the present embodiment, there is no concern thereof, and the in-plane uniformity of optical characteristics can be improved.

A ratio of the electrode width to the slit width (electrode width:slit width) of the comb-teeth electrode 11 is preferably from 1:2 to 1:6. By adopting such an aspect, alignment uniformity can be further improved. Consequently, the degree of polarization of emitted light can be improved. A ratio of the electrode width to the slit width (electrode width:slit width) of the comb-teeth electrode 11 is more preferably from 1:2.5 to 1:5, and a ratio of the electrode width to the slit width (electrode width:slit width) of the comb-teeth electrode 11 is further preferably from 1:3 to 1:4.

A ratio of the thickness of the liquid crystal layer 300 to the slit width of the comb-teeth electrode 11 (thickness of liquid crystal layer:slit width) is preferably from 1:2.5 to 1:10. By adopting such an aspect, alignment uniformity can be further improved. Consequently, the degree of polarization of emitted light can be improved. A ratio of the thickness of the liquid crystal layer 300 to the slit width of the comb-teeth electrode 11 (thickness of liquid crystal layer:slit width) is more preferably from 1:3 to 1:8, and a ratio of the thickness of the liquid crystal layer 300 to the slit width of the comb-teeth electrode 11 (thickness of liquid crystal layer:slit width) is further preferably from 1:4 to 1:6.

The comb-teeth electrode 11 includes a pixel electrode which is a comb-teeth electrode, and a common electrode which is a comb-teeth electrode. The pixel electrode and the common electrode can be formed in the following manner: for example, a transparent conductive material such as indium tin oxide (ITO), indium zinc oxide (IZO), zinc oxide (ZnO) or tin oxide (SnO), or an alloy thereof is film-formed by a sputtering method or the like to have a single or multiple layers, and thereafter patterning is performed thereon using a photolithographic method.

An azimuth angle in the extension direction 11A of the comb-teeth electrode 11 is preferably, for example, 115° or more and 155° or less. By adopting such an aspect, a modulation state can be realized when no voltage is applied or a low-frequency voltage is applied, and a non-modulation state can be realized when a high-frequency voltage is applied.

In addition, an azimuth angle in the extension direction 11A of the comb-teeth electrode 11 is preferably, for example, 25° or more and 65° or less. By adopting such an aspect, a non-modulation state can be realized when no voltage is applied or a low-frequency voltage is applied, and a modulation state can be realized when a high-frequency voltage is applied.

As illustrated in FIGS. 3 and 4, the comb-teeth electrodes 11 are disposed to be switchable between a first state in which the dual-frequency drive liquid crystal molecules 311 on the first substrate 100 side are aligned in the first alignment direction 311A and a second state in which the dual-frequency drive liquid crystal molecules 311 on the first substrate 100 side are aligned in the second alignment direction 311B perpendicular to the first alignment direction 311A in a plan view, by applying a voltage to the liquid crystal layer 300.

The switching between the first state and the second state controls the polarization state of light incident on the liquid crystal cell 11C. When circularly-polarized light is incident on the liquid crystal cell 11C, the circularly-polarized light is converted into first linearly polarized light in the first state, and the circularly-polarized light is converted into second linearly polarized light having a polarization direction perpendicular to the polarization direction of the first linearly polarized light in a plan view in the second state. When linearly polarized light is incident on the liquid crystal cell 11C, the linearly polarized light is converted into first circularly-polarized light in the first state, and the linearly polarized light is converted into second circularly-polarized light that rotates in a direction opposite to the rotation direction of the first circularly-polarized light in the second state. By adopting such an aspect, it is possible to switch, in a wide band, between a state in which circularly-polarized light incident on the liquid crystal element 10 is emitted without being modulated and a state in which circularly-polarized light incident on the liquid crystal element 10 is modulated and emitted, while reducing the thickness of the liquid crystal element 10. Thus, the liquid crystal element 10 can switch between polarization modulation and polarization non-modulation in a wide band, and can be made thinner.

In the liquid crystal element 10 according to the present embodiment which includes the liquid crystal cell 11C and the retardation layer 500, the first state is a polarization modulation state in which polarization states of right and left handed circularly-polarized light beams are converted, and the second state is a polarization non-modulation state in which polarization states of right and left handed circularly-polarized light beams are not converted. The alignment direction of the dual-frequency drive liquid crystal molecules on the first substrate side refers to the alignment direction of the dual-frequency drive liquid crystal molecules located at the interface of the liquid crystal layer on the first substrate side. Similarly, the alignment direction of the dual-frequency drive liquid crystal molecules on the second substrate side refers to the alignment direction of the dual-frequency drive liquid crystal molecules located at the interface of the liquid crystal layer on the second substrate side.

The alignment direction of the dual-frequency drive liquid crystal molecules on the first substrate side and the alignment direction of the dual-frequency drive liquid crystal molecules on the second substrate side can be measured from a Mueller matrix output by measuring a liquid crystal cell with Axoscan (manufactured by Axometrics, Inc.). In addition, the alignment direction of the dual-frequency drive liquid crystal molecules on the first substrate side and the alignment direction of the dual-frequency drive liquid crystal molecules on the second substrate side can also be obtained by software for fitting a cell thickness and a twist angle of liquid crystal in Axoscan.

### Liquid Crystal Layer

The liquid crystal layer 300 contains the dual-frequency drive liquid crystal molecules 310. Thereby, the liquid crystal element 10 can switch between two liquid crystal alignment states (that is, a modulation state and a non-modulation state) by the comb-teeth electrode 11 provided on only one substrate. In addition, even when the liquid crystal layer 300 is sandwiched between two weak anchoring alignment films (in the present embodiment, the first weak anchoring horizontal alignment film 411 and the second weak anchoring horizontal alignment film 421) because the liquid crystal layer 300 contains the dual-frequency drive liquid crystal molecules 310, alignment stability can be enhanced by performing a voltage application realignment process. When normal liquid crystal molecules are used, the alignment stabilization itself is possible, but it is not possible to switch between a modulation state and a non-modulation state only by the comb-teeth electrode provided on one substrate.

The dual-frequency drive liquid crystal molecules 310 behave as positive liquid crystal molecules having a positive dielectric constant anisotropy (As) when a low-frequency voltage is applied thereto, and behave as negative liquid crystal molecules having a negative as when a high-frequency voltage is applied thereto. A single compound may behave as described above, or a mixture of a plurality of compounds may behave as described above. In this specification, it is also referred to as dual-frequency drive liquid crystal molecules in either case.

When dual-frequency drive liquid crystal is used, liquid crystal molecules are aligned in a direction perpendicular to the extension direction of the comb-teeth electrodes by performing low frequency driving on one comb-teeth electrode even when comb-teeth electrodes having different angles are not provided on upper and lower substrates (the first substrate 100 and the second substrate 200), and liquid crystal molecules are aligned in the extension direction of the comb-teeth electrodes by performing high frequency driving, and thus the electrode configuration can be simplified. Note that as is expressed by the following (Formula L).

Δε=(dielectric constant in long axis direction of liquid crystal molecules)−(dielectric constant in short axis direction of liquid crystal molecules) Formula L

A low frequency is, for example, 1 Hz or higher and 1 kHz or less, and a high frequency is 10 kHz or higher and 1 MHz or less. A frequency at which the polarity of as is reversed is referred to as a crossover frequency, and can be appropriately adjusted by a molecular structure of a liquid crystal material, a mixing ratio of a mixture, or the like.

The dual-frequency drive liquid crystal molecules 310 are twist-aligned between the first substrate 100 and the second substrate 200. In each of the first state and the second state, the dual-frequency drive liquid crystal molecules 310 are twist-aligned from the first substrate 100 side to the second substrate 200 side. The direction of the twist of the dual-frequency drive liquid crystal molecules 310 in the first state is the same as the direction of the twist of the dual-frequency drive liquid crystal molecules 310 in the second state. Thereby, the liquid crystal element 10 can obtain good polarization modulation characteristics in both of the two states (the non-modulation state and the modulation state).

The twist direction of the dual-frequency drive liquid crystal molecules 310 in a voltage applied state is the same as the twist direction thereof in a voltage non-applied state. For example, when the twist direction in the voltage applied state is clockwise, the twist direction in the voltage non-applied state is also clockwise, and when the twist direction in the voltage applied state is counterclockwise, the twist direction in the voltage non-applied state is also counterclockwise.

The twist alignment of the dual-frequency drive liquid crystal molecules 310 can be realized by adding a chiral agent to the liquid crystal material, for example. The chiral agent is not particularly limited, and a known chiral agent can be used. As the chiral agent, for example, S-811 (manufactured by Merck) can be used.

In a plan view, an angle formed by the alignment direction (first alignment direction) 311A of the dual-frequency drive liquid crystal molecules 311 on the first substrate 100 side and the alignment direction 312A of the dual-frequency drive liquid crystal molecules 312 on the second substrate 200 side in the first state is preferably 57° or more and 82° or less, more preferably 58° or more and 81° or less, and further preferably 59° or more and 79° or less. The liquid crystal element 10 according to such an aspect can more effectively switch between polarization modulation and polarization non-modulation in a wide band. Hereinafter, in a plan view, an angle formed by the alignment direction of the dual-frequency drive liquid crystal molecules on the first substrate 100 side and the alignment direction of the dual-frequency drive liquid crystal molecules on the second substrate side is also referred to as a twist angle.

In a plan view, an angle formed by the alignment direction (second alignment direction) 311B of the dual-frequency drive liquid crystal molecules 311 on the first substrate 100 side and an alignment direction 312B of the dual-frequency drive liquid crystal molecules 312 on the second substrate 200 side in the second state is preferably 50° or more and 85° or less, more preferably 55° or more and 83° or less, and further preferably 57° or more and 80° or less. The liquid crystal element 10 according to such an aspect can more effectively switch between polarization modulation and polarization non-modulation in a wide band. The twist angle in the first state and the twist angle in the second state may be the same or different, but are preferably the same.

The twist angle when no voltage is applied is preferably 67° or more and 92° or less, more preferably 73° or more and 85° or less, and further preferably 76° or more and 82° or less. Since the twist angle decreases with the application of a voltage, both the twist angles in the first state and the second state can be set to be in the above-described suitable range by setting the twist angle when no voltage is applied, as described above. Therefore, the liquid crystal element 10 can more effectively switch between the polarization modulation and the polarization non-modulation in a wide band.

The alignment direction of the dual-frequency drive liquid crystal molecules 310 located at the center of the liquid crystal layer 300 in the thickness direction is also referred to as a liquid crystal average alignment direction. The liquid crystal average alignment direction is disposed between the alignment direction of the dual-frequency drive liquid crystal molecules 311 on the first substrate 100 side and the alignment direction of the dual-frequency drive liquid crystal molecules 312 on the second substrate 200 side.

As illustrated in FIGS. 3 and 4, when no voltage is applied to the comb-teeth electrodes 11 (also referred to as a voltage off state), the alignment direction (liquid crystal average alignment direction) 310A of the dual-frequency drive liquid crystal molecules 310 located at the center of the liquid crystal layer 300 in the thickness direction is perpendicular to the extension direction 11A of the comb-teeth electrodes 11. For example, when liquid crystal realignment is performed while applying a low-frequency voltage when manufacturing the liquid crystal element 10, the alignment direction of the dual-frequency drive liquid crystal molecules 310 located at the center of the liquid crystal layer 300 in the thickness direction is perpendicular to the extension direction 11A of the comb-teeth electrodes 11 in a voltage non-applied state. The voltage applied at this time needs to be lower than the crossover frequency of the dual-frequency drive liquid crystal molecules 310. For example, in the range of 1 Hz or more and 1 kHz or less, a range of 1 V or more and 10 V or less is preferable. By performing this process, the liquid crystal average alignment direction 310A of the dual-frequency drive liquid crystal molecules 310 when no voltage is applied to the comb-teeth electrodes 11 is uniformly aligned in a state of being perpendicular to the extension direction 11A of the comb-teeth electrodes 11.

In the present embodiment, attention is paid to a relationship between the liquid crystal average alignment direction 310A and the extension direction 11A of the comb-teeth electrodes 11, not to the alignment directions of the dual-frequency drive liquid crystal molecules 311 on the first substrate 100 side and the dual-frequency drive liquid crystal molecules 312 on the second substrate 200 side. This is because the dual-frequency drive liquid crystal molecules 310 (also referred to as bulk dual-frequency drive liquid crystal molecules) located in a region away from the substrate are more likely to be affected by the extension direction 11A (the direction of an electric field E) of the comb-teeth electrodes 11 than the dual-frequency drive liquid crystal molecules 311 on the first substrate 100 side and the dual-frequency drive liquid crystal molecules 312 on the second substrate 200 side.

For example, when the twist angle is set to 65° instead of 70°, the alignment directions of the dual-frequency drive liquid crystal molecules 311 on the first substrate 100 side and the dual-frequency drive liquid crystal molecules 312 on the second substrate 200 side are changed such that an angle formed by the dual-frequency drive liquid crystal molecules 311 on the first substrate 100 side and the dual-frequency drive liquid crystal molecules 312 on the second substrate 200 side is reduced, but the average liquid crystal alignment direction is not changed. The same phenomenon occurs depending on the concentration of the chiral agent added to the liquid crystal material, but the liquid crystal average alignment direction is not changed. Thus, in the present embodiment, attention is paid to the liquid crystal average alignment direction 310A, not to the alignment direction of the dual-frequency drive liquid crystal molecules 311 on the first substrate 100 side and the alignment direction of the dual-frequency drive liquid crystal molecules 312 on the second substrate 200 side.

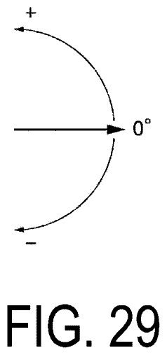

In the liquid crystal element 10 of the present embodiment, in the first state, the alignment direction (first alignment direction) 311A of the dual-frequency drive liquid crystal molecules 311 on the first substrate 100 side is preferably 70° or more and 120° or less, more preferably 75° or more and 110° or less, and further preferably 80° or more and 99° or less. In the second state, the alignment direction (first alignment direction) 311A of the dual-frequency drive liquid crystal molecules 311 on the first substrate 100 side is preferably −20° or more and 15° or less, more preferably −15° or more and 12° or less, and further preferably −10° or more and 9° or less. The liquid crystal element 10 according to such an aspect can more effectively switch between polarization modulation and polarization non-modulation in a wide band. Here, when the liquid crystal element 10 is viewed in a plan view from a light emission side, the 3 o'clock direction of the clock is set as a reference (0°), the counterclockwise direction from the reference azimuth is set as a positive (+) angle, and the clockwise direction from the reference azimuth is set as a negative (−) angle (see FIG. 29 to be described below).

Weak Anchoring Horizontal Alignment Film A weak anchoring alignment film refers to an alignment film having a weak alignment regulating force with respect to liquid crystal molecules. The material of the weak anchoring horizontal alignment film is not particularly limited, and any known material can be used. As the weak anchoring horizontal alignment film, for example, those described in paragraphs 0095 to 0102 of Japanese Patent No. 7458437 are suitably used, and in order to improve reliability and productivity, it is also preferable that the horizontal alignment film be formed of two or more polymers. In order to improve panel strength (sealing adhesion), it is also desirable to use a material having a polymerizable part that chemically bonds to a sealing material.

The first weak anchoring horizontal alignment film 411 preferably has an azimuthal anchoring energy of less than 1×10⁻⁴ J/m². Thereby, the liquid crystal element 10 can further improve polarization modulation performance. The second weak anchoring horizontal alignment film 421 preferably has an azimuthal anchoring energy of less than 1×10⁻⁴ J/m². Thereby, the liquid crystal element 10 can further improve polarization modulation performance.

The azimuthal anchoring energy can be calculated by various known methods such as a torque balance method, a Neel wall method, calculation from an electric field response threshold value, and calculation from a rotating magnetic field. Note that the azimuthal anchoring energy described in this specification is calculated using a calculation method from an electric field response threshold value. The lower limit of the azimuthal anchoring energy of the weak anchoring alignment film is not particularly limited, but the azimuthal anchoring energy of the weak anchoring alignment film is, for example, 1×10⁻¹⁰ J/m² or more.

The azimuthal anchoring energy of the first weak anchoring horizontal alignment film 411 is preferably 1×10⁻¹⁰ J/m² or more and less than 1×10⁻⁴ J/m², and more preferably 1×10⁻⁸ J/m² or more and 1×10⁻⁵ J/m² or less. Thereby, the liquid crystal element 10 can more effectively switch between polarization modulation and polarization non-modulation in a wide band.

The azimuthal anchoring energy of the second weak anchoring horizontal alignment film 421 is preferably 1×10⁻¹⁰ J/m² or more and less than 1×10⁻⁴ J/m², and more preferably 1×10⁻⁸ J/m² or more and 1×10⁻⁵ J/m² or less. Thereby, the liquid crystal element 10 can more effectively switch between polarization modulation and polarization non-modulation in a wide band.

A ratio of the azimuthal anchoring energy of the second weak anchoring horizontal alignment film 421 to the azimuthal anchoring energy of the first weak anchoring horizontal alignment film 411 (that is, (azimuthal anchoring energy of second weak anchoring horizontal alignment film 421)/(azimuthal anchoring energy of first weak anchoring horizontal alignment film 411)) is preferably 10 or less. Thereby, the liquid crystal element 10 can further improve alignment stability. A ratio of the azimuthal anchoring energy of the second weak anchoring horizontal alignment film 421 to the azimuthal anchoring energy of the first weak anchoring horizontal alignment film 411 is more preferably 8 or less, and further preferably 6 or less.

A ratio of the azimuthal anchoring energy of the second weak anchoring horizontal alignment film 421 to the azimuthal anchoring energy of the first weak anchoring horizontal alignment film 411 is, for example, preferably 0.1 or more, more preferably 0.3 or more, and further preferably 0.5 or more.

A ratio of the azimuthal anchoring energy of the second weak anchoring horizontal alignment film 421 to the azimuthal anchoring energy of the first weak anchoring horizontal alignment film 411 is preferably 0.1 or more and 10 or less, more preferably 0.3 or more and 8 or less, and further preferably 0.5 or more and 6 or less.

The weak anchoring alignment film can be formed by performing alignment processing or without performing alignment processing. Specifically, the weak anchoring alignment film may be a rubbing alignment film, a photo-alignment film, or an unprocessed alignment film that is not subjected to alignment processing.

The first weak anchoring horizontal alignment film 411 and the second weak anchoring horizontal alignment film 421 are preferably unprocessed alignment films that have not been subjected to alignment processing. That is, it is preferable that the first weak anchoring horizontal alignment film 411 and the second weak anchoring horizontal alignment film 421 do not have uniaxial alignment. Thereby, the liquid crystal element 10 can further improve alignment stability. From the viewpoint of improving alignment stability, the first weak anchoring horizontal alignment film 411 and the second weak anchoring horizontal alignment film 421 preferably have an in-plane retardation Re of less than 1 nm.

The unprocessed alignment film is obtained, for example, by forming an alignment film material containing an alignment film polymer on a substrate. Examples of the alignment film polymer include polyimide and polyhexyl methacrylate. The alignment film polymer contained in the unprocessed alignment film may be one type or two or more types.

Examples of the alignment film polymer contained in the unprocessed alignment film include polymers described in WO 2017/034023, in addition to polyimide and polyhexyl methacrylate, and particularly, polyalkylene oxides such as polyethylene glycol and polypropylene glycol are preferable.

The horizontal alignment film has a function of aligning the dual-frequency drive liquid crystal molecules in the liquid crystal layer in the horizontal direction with respect to the surface of the horizontal alignment film when no voltage is applied. The “dual-frequency drive liquid crystal molecules aligning in the horizontal direction with respect to the surface of the horizontal alignment film” means that a pretilt angle of the dual-frequency drive liquid crystal molecules is 0° or more and 5° or less with respect to the surface of the horizontal alignment film, preferably 0° or more and 2° or less, and further preferably 0° or more and 1° or less. The pretilt angle of the dual-frequency drive liquid crystal molecules means an angle at which the major axes of the dual-frequency drive liquid crystal molecules are tilted with respect to the major surface of the alignment film when no voltage is applied to the liquid crystal layer.

From the viewpoint of improving alignment stability, the first weak anchoring horizontal alignment film 411 preferably contains a polymer having at least one of a group represented by the structural formula (P1) or a group represented by the structural formula (P2).

The second weak anchoring horizontal alignment film 421 preferably contains a polymer having at least one of a group represented by the structural formula (P1) or a group represented by the structural formula (P2). Thereby, the liquid crystal element 10 can further improve polarization modulation performance and alignment stability.

The first weak anchoring horizontal alignment film 411 and the second weak anchoring horizontal alignment film 421 each preferably contain a polymer having at least one of a group represented by the structural formula (P1) or a group represented by the structural formula (P2). Thereby, the liquid crystal element 10 can further improve polarization modulation performance and alignment stability. The structure of the polymer contained in the first weak anchoring horizontal alignment film 411 and the structure of the polymer contained in the second weak anchoring horizontal alignment film 421 may be the same as or different from each other. It is more preferable that these are the same because the anchoring energy of the first weak anchoring film and the anchoring energy of the second weak anchoring film can be made the same. In addition, from the viewpoint of productivity, it is preferable that these be the same.

It is preferable that light incident on the liquid crystal element 10 be circularly-polarized light. In this case, it is possible to implement the liquid crystal element 10 capable of switching the polarization state of circularly-polarized light.

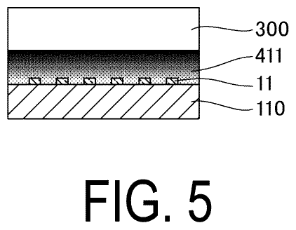

FIG. 5 is a schematic cross-sectional view illustrating an example of a weak anchoring alignment film included in the liquid crystal element of the present embodiment. It is preferable that at least one horizontal alignment film (the first weak anchoring horizontal alignment film 411 in the present embodiment) out of the first weak anchoring horizontal alignment film 411 and the second weak anchoring horizontal alignment film 421 be in contact with the comb-teeth electrode 11, and contain at least two types of polymers having different refractive indices, and a polymer having the smallest refractive index among the at least two types of polymers be in contact with the liquid crystal layer 300.

A transparent electrode (comb-teeth electrode 11) has a larger refractive index than those of a glass substrate (first support substrate 110 and second support substrate 210) and the liquid crystal layer 300, and thus has a large optical loss due to unnecessary diffraction, haze, unnecessary reflection, and the like. However, by adjusting the refractive index of the alignment film material and applying the alignment film material to the surface of the transparent electrode (comb-teeth electrode 11), it is possible to reduce a difference in refractive index between layers and reduce the optical loss thereof. That is, at least one horizontal alignment film (the first weak anchoring horizontal alignment film 411 in the present embodiment) out of the first weak anchoring horizontal alignment film 411 and the second weak anchoring horizontal alignment film 421 is in contact with the comb-teeth electrode 11, and contains at least two types of polymers having different refractive indices, and the polymer having the smallest refractive index out of the at least two types of polymers is in contact with the liquid crystal layer 300, and thus it is possible to reduce a difference in refractive index between layers and reduce an optical loss.

### Retardation Layer

The liquid crystal element 10 includes the retardation layer 500 on at least one of the side of the first substrate 100 opposite to the liquid crystal layer 300 or the side of the second substrate 200 opposite to the liquid crystal layer 300. The retardation layer 500 may be disposed on both the side of the first substrate 100 opposite to the liquid crystal layer 300 and the side of the second substrate 200 opposite to the liquid crystal layer 300, but is preferably disposed on one side in consideration of, for example, an improvement in productivity.

The total number of retardation films configuring the retardation layer 500 is preferably two or more. In particular, the retardation layer 500 disposed on one side of the liquid crystal layer 300 is preferably configured with two or more retardation films. When the retardation layer 500 is disposed on both sides of the liquid crystal layer 300, it is preferable that the retardation layer 500 disposed on at least one side be configured with two or more retardation films. In particular, it is preferable that the retardation layer 500 disposed on the side of the second substrate 200 opposite to the liquid crystal layer 300 be configured with at least two retardation films, and the two or more retardation films include a first quarter-wavelength film 1Q and a second quarter-wavelength film 2Q, which will be described below.

The retardation layer 500 includes the first quarter-wavelength film 1Q and the second quarter-wavelength film 2Q in this order from the side closer to the liquid crystal layer 300. The liquid crystal element 10 according to such an aspect can switch between polarization modulation and polarization non-modulation in a wider band. In order to allow the liquid crystal element 10 to exert this effect more, it is preferable that the first quarter-wavelength film 1Q and the second quarter-wavelength film 2Q be disposed on the side of the second substrate 200 opposite to the liquid crystal layer 300.

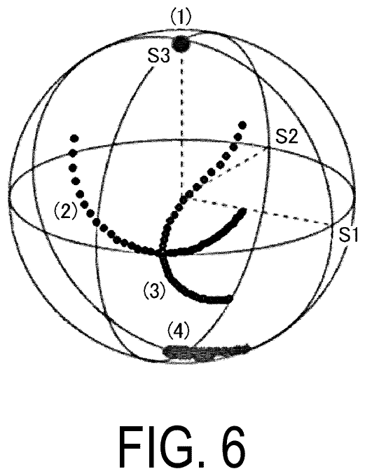

The action mechanism of the liquid crystal element 10 including the liquid crystal cell 11C, the first quarter-wavelength film 1Q, and the second quarter-wavelength film 2Q in this order from the incident side to the emission side will be described below with reference to FIGS. 1, 6, and the like.

When no voltage is applied to the comb-teeth electrodes 11 or when the dual-frequency drive liquid crystal molecules 310 are driven at a frequency lower than the crossover frequency (also referred to as “low-frequency driving”), circularly-polarized light (for example, right handed circularly-polarized light) incident on the liquid crystal cell 11C becomes first linearly polarized light after passing through the liquid crystal cell 11C. Further, the first linearly polarized light passes through the first quarter-wavelength film 1Q and the second quarter-wavelength film 2Q to be thereby converted into circularly-polarized light (for example, left handed circularly-polarized light) having a polarization state different from that of the circularly-polarized light incident on the liquid crystal cell 11C in a wide band. In this manner, in the first state, polarization modulation in which circularly-polarized light incident on the liquid crystal element 10 is converted into circularly-polarized light having a different polarization state (for example, right handed circularly-polarized light is converted into left handed circularly-polarized light) and emitted is realized in a wide band.

In a state where a voltage is applied to the comb-teeth electrodes 11, the circularly-polarized light (for example, righthanded circularly-polarized light) incident on the liquid crystal cell 11C passes through the liquid crystal cell 11C and then becomes second linearly polarized light having a polarization direction perpendicular to the polarization direction of the first linearly polarized light in a plan view. That is, the second state is realized. Further, the second linearly polarized light passes through the first quarter-wavelength film 1Q and the second quarter-wavelength film 2Q to be thereby emitted in a wide band as circularly-polarized light (for example, right handed circularly-polarized light) having the same polarization state as the circularly-polarized light incident on the liquid crystal cell 11C. In this manner, in the second state, polarization non-modulation in which circularly-polarized light incident on the liquid crystal element 10 is emitted while maintaining the same polarization state (for example, maintaining right handed circularly-polarized light) is realized in a wide band.

In the present embodiment, an aspect in which the liquid crystal cell 11C, the first quarter-wavelength film 1Q, and the second quarter-wavelength film 2Q are provided in this order from the incident side toward the emission side will be described, but the order of layering of these films may be reversed, and specifically, the second quarter-wavelength film 2Q, the first quarter-wavelength film 1Q, and the liquid crystal cell 11C may be provided in this order from the incident side toward the emission side. In this case, in the first state, polarization modulation in which circularly-polarized light incident on the liquid crystal element 10 is converted into circularly-polarized light having a different polarization state (for example, right handed circularly-polarized light is converted into left handed circularly-polarized light) and emitted is realized in a wide band, and in the second state, polarization non-modulation in which circularly-polarized light incident on the liquid crystal element 10 is emitted while maintaining the same polarization state (for example, while maintaining right handed circularly-polarized light) is realized in a wide band. In the case where the order of layering is reversed, a slow axis 1QA of the first quarter-wavelength films 1Q and a slow axis 2QA of the second quarter-wavelength films 2Q are adjusted as appropriate.

FIG. 6 is a diagram illustrating Stokes plots of respective layers in the first state in the liquid crystal element 10 according to the present embodiment. FIG. 6 illustrates a polarization state (the role of each layer) when light is transmitted through each layer in the first state. The principle of polarization modulation of the liquid crystal element 10 according to the present embodiment will be described in detail with reference to a Poincare sphere in FIG. 6.

As indicated by (1) in FIG. 6, right handed circularly-polarized light (S3=+1) is incident on the liquid crystal cell 11C.

After light passes through the liquid crystal cell 11C twisted by 70°, the light is once converted to the polarization state indicated by the plot of (2) in FIG. 6. Dots in each plot represent plots of different wavelengths of 380 nm to 780 nm. Light near the wavelength of 550 nm is linearly polarized light (on the equator on the Poincare sphere), but light having any of the other wavelengths is plotted on the northern hemisphere of the Poincare sphere and becomes elliptically polarized light.

Thereafter, the light passes through the first quarter-wavelength film 1Q (specifically, a quarter-wavelength film with reverse chromatic dispersion), and is indicated by the plot of (3) in FIG. 6.

Further, when the light passes through the second quarter-wavelength film 2Q (specifically, a quarter-wavelength film with flat chromatic dispersion), the light at substantially any wavelength becomes left handed circularly-polarized light (at the south pole position on the Poincare sphere) and is emitted as indicated by the plot of (4) in FIG. 6. That is, it can be seen that modulation from right handed circularly-polarized light to the left handed circularly-polarized light is performed.

Similarly, in the second state (non-modulation state), light passes through the liquid crystal cell 11C twisted by 70°, and then once becomes linearly polarized light. However, since the entire orientation of the liquid crystal cell 11C is rotated by 90°, the light becomes linearly polarized light that is different from that in the first state (modulation state) by approximately 90°. Thereafter, the light passes through the first quarter-wavelength film 1Q and the second quarter-wavelength film 2Q, the light at any wavelength becomes right handed circularly-polarized light. That is, the right handed circularly-polarized light can be emitted as right handed circularly-polarized light and is not modulated.

In this manner, the first state and the second state have the same orientation of the dual-frequency drive liquid crystal molecules 310, which is twisted by 70°, and the entire system has a relationship of being different by 90°. When the liquid crystal element 10 of the present embodiment is used, it is possible to reversibly switch between two states, that is, the first state and the second state, and it is possible to realize a thin switchable half wave plate (sHWP) element having a wide band both at the time of polarization non-modulation and at the time of polarization modulation. Note that it is possible to change which of the modulation state and the non-modulation state is set at the time of driving, depending on the arrangement of the first quarter-wavelength film 1Q, the second quarter-wavelength film 2Q, and the substrate.

The first quarter-wavelength film 1Q and the second quarter-wavelength film 2Q impart an in-plane retardation of 20 nm or more and 240 nm or less to light having at least a wavelength of 550 nm.

Examples of the material of the quarter-wavelength film include a photopolymerizable liquid crystal material, and the like. Examples of the structure of the photopolymerizable liquid crystal material include a structure having a photopolymerizable group such as an acrylate group or a methacrylate group at the terminal of the skeleton of a liquid crystal molecule.

The quarter-wavelength film can be formed by, for example, the following method. First, a photopolymerizable liquid crystal material is dissolved in an organic solvent such as propylene glycol monomethyl ether acetate (PGMEA). Next, the obtained solution is applied onto the surface of a substrate (for example, a polyethylene terephthalate (PET) film) to form a coating film of the solution. Thereafter, the coating film of the solution is subjected to temporary baking, light irradiation (for example, ultraviolet irradiation), and main baking in this order, thereby forming a quarter-wavelength film. Further, a liquid crystal polymer obtained by adding a chiral agent to the photopolymerizable liquid crystal material and polymerizing the material in a state of being twisted by 70° may be used as the quarter-wavelength film.

As the quarter-wavelength film, for example, a stretched polymer film can also be used. Examples of the material of the polymer film include cycloolefin polymer, polycarbonate, polysulfone, polyethersulfone, polyethylene terephthalate, polyethylene, polyvinyl alcohol, norbornene, triacetyl cellulose, diacetyl cellulose, and the like.

The first quarter-wavelength film 1Q preferably has reverse wavelength dispersion characteristics. Thereby, the liquid crystal element 10 can switch between polarization modulation and polarization non-modulation in a wider band. Here, in this specification, “wavelength dispersion of the retardation film” refers to a correlation between an absolute value of a retardation imparted by the retardation film and the wavelength of incident light. A property in which an absolute value of a retardation imparted by a retardation film does not change even when the wavelength of incident light changes in a visible light region is referred to as “flat wavelength dispersion characteristics”. In addition, a property in which an absolute value of a retardation imparted by a retardation film decreases as the wavelength of incident light increases in a visible light region is referred to as a “normal wavelength dispersion characteristic”, and a property in which an absolute value of a retardation imparted by a retardation film increases as the wavelength of incident light increases in a visible light region is referred to as a “reverse wavelength dispersion characteristic”.

From the viewpoint of allowing the liquid crystal element 10 to switch between polarization modulation and polarization non-modulation in a wider band, the in-plane retardation (also referred to as “Re (450)/Re (550)”) of the first quarter-wavelength film 1Q at a wavelength of 450 nm with respect to the in-plane retardation of the first quarter-wavelength film 1Q at a wavelength of 550 nm is preferably 0.7 times or more and 1.1 times or less. In addition, the in-plane retardation (also referred to as “Re (650)/Re (550)”) of the first quarter-wavelength film 1Q at a wavelength of 650 nm with respect to the in-plane retardation of the first quarter-wavelength film 1Q at a wavelength of 550 nm is preferably 0.9 times or more and 1.3 times or less.

The in-plane retardation of the first quarter-wavelength film 1Q at a wavelength of 550 nm is preferably 30 nm or more and 230 nm or less.

The second quarter-wavelength film 2Q preferably has a flat wavelength dispersibility. Thereby, the liquid crystal element 10 can switch between polarization modulation and polarization non-modulation in a wider band. From this point of view, the in-plane retardation of the second quarter-wavelength film 2Q at a wavelength of 550 nm is preferably 110 nm or more and 175 nm or less.

When the azimuth angle in the alignment direction 311A of the dual-frequency drive liquid crystal molecules 311 on the first substrate 100 side in the first state is 0°, the azimuth angle of the slow axis (the slow axis 1QA of the first quarter-wavelength film 1Q in the present embodiment) of the quarter-wavelength film on the side farther from an emission side of a light beam out of the first quarter-wavelength film 1Q and the second quarter-wavelength film 2Q is preferably 43° or more and 63° or less, and more preferably 48° or more and 66° or less. Thereby, the liquid crystal element 10 can switch between polarization modulation and polarization non-modulation in a wider band.

When the azimuth angle in the alignment direction 311A of the dual-frequency drive liquid crystal molecules 311 on the first substrate 100 side in the first state is 0°, the azimuth angle of the slow axis (the slow axis 2QA of the second quarter-wavelength film 2Q in the present embodiment) of the quarter-wavelength film closer to an emission side of a light beam out of the first quarter-wavelength film 1Q and the second quarter-wavelength film 2Q is preferably more than 0° and 25° or less, and more preferably 3° or more and 22° or less. Thereby, the liquid crystal element 10 can switch between polarization modulation and polarization non-modulation in a wider band.

An angle formed by the slow axis 1QA of the first quarter-wavelength film 1Q and the slow axis 2QA of the second quarter-wavelength film 2Q is preferably 40° or more and 50° or less, more preferably 42° or more and 48° or less, further preferably 44° or more and 46° or less, and particularly preferably 45°.

At least one of the first quarter-wavelength film 1Q or the second quarter-wavelength film 2Q is a positive A plate or a negative A plate. Thereby, the liquid crystal element 10 can more effectively switch between polarization modulation and polarization non-modulation in a wide band.

As described above, the retardation layer 500 may be disposed on both the side of the first substrate 100 opposite to the liquid crystal layer 300 and the side of the second substrate 200 opposite to the liquid crystal layer 300. For example, it is preferable that the retardation layer 500 disposed on the side of the second substrate opposite to the liquid crystal layer 300 include the first quarter-wavelength film 1Q and the second quarter-wavelength film 2Q, and the retardation layer 500 disposed on the side of the first substrate 100 opposite to the liquid crystal layer 300 include a positive C plate. For convenience, the retardation layer 500 disposed on the side of the first substrate 100 opposite to the liquid crystal layer 300 is also referred to as a retardation layer 501. In this manner, it is preferable that the liquid crystal element 10 include the first quarter-wavelength film 1Q and the second quarter-wavelength film 2Q on the side of the second substrate 200 opposite to the liquid crystal layer 300, and include a positive C plate on the side of the first substrate 100 opposite to the liquid crystal layer 300. Thereby, the liquid crystal element 10 can more effectively switch between polarization modulation and polarization non-modulation in a wide band.

The thickness retardation (Rth) of the positive C plate is preferably 0 nm or more and 400 nm or less, and more preferably 0 nm or more and 380 nm or less. It is preferable that the retardation layer 501 disposed on the side of the first substrate 100 opposite to the liquid crystal layer 300 satisfy nz>nx−ny as a whole layer. In this case, the retardation layer 501 may be configured with one or two or more retardation films as long as the retardation layer satisfies nz>nx−ny as a whole layer.

The liquid crystal element 10 preferably satisfies any one of the following (i) to (iv).
(i) The first quarter-wavelength film 1Q and the second quarter-wavelength film 2Q are positive A plates.
(ii) The first quarter-wavelength film 1Q is a positive A plate, the second quarter-wavelength film 2Q is a negative A plate, and the liquid crystal element 10 further includes a retardation film other than the first quarter-wavelength film 1Q and the second quarter-wavelength film 2Q.
(iii) The first quarter-wavelength film 1Q is a negative A plate, and the second quarter-wavelength film 2Q is a positive A plate.
(iv) The first quarter-wavelength film 1Q and the second quarter-wavelength film 2Q are negative A plates.

Hereinafter, a case where the liquid crystal element 10 satisfies the above (i), that is, a case where both the first quarter-wavelength film 1Q and the second quarter-wavelength film 2Q are positive A plates will be described. The cases where the liquid crystal element 10 satisfies the above (ii), (iii), and (iv) will be described below in second, third, and fourth embodiments, respectively.

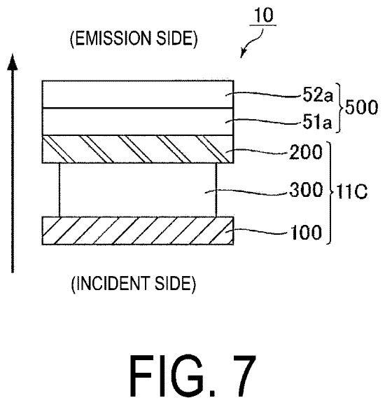

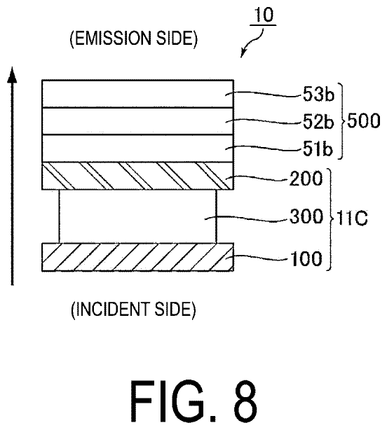

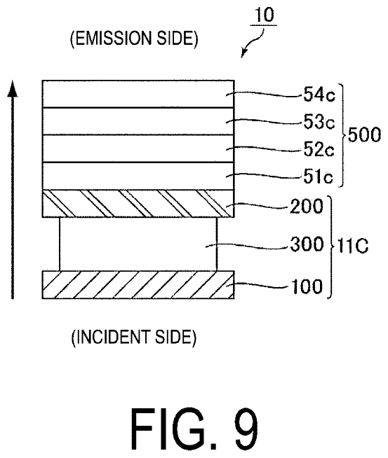

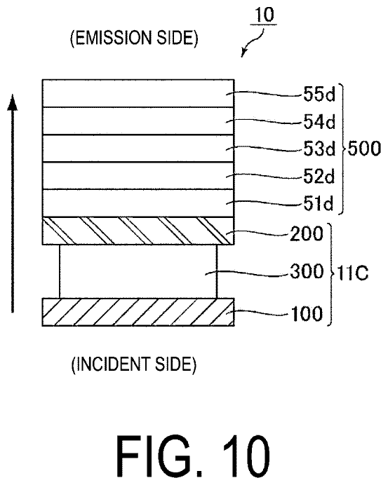

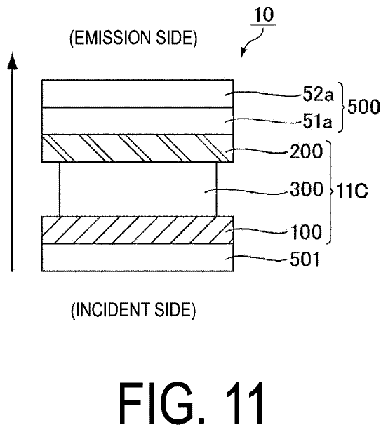

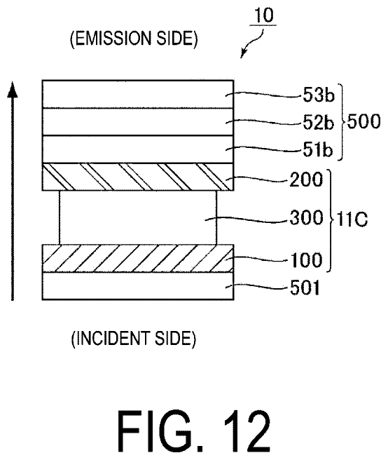

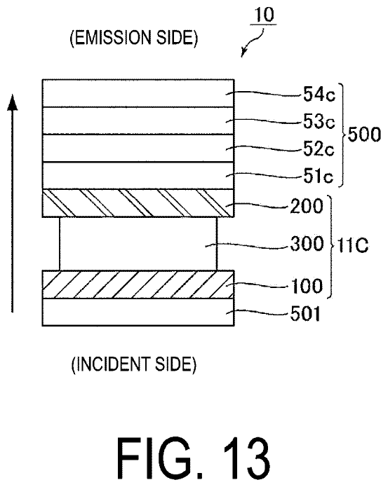

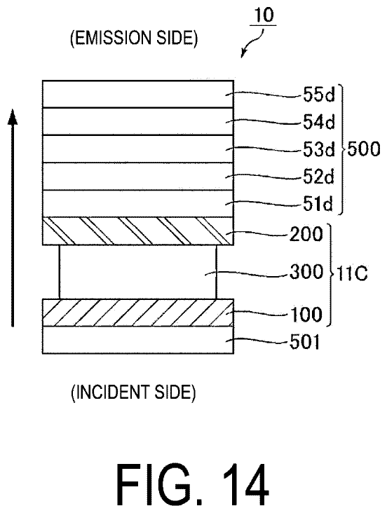

FIGS. 7 to 14 are schematic cross-sectional views specifically illustrating an example of the layer configuration of the liquid crystal element 10 of the present embodiment. As described above, it is preferable that the retardation layer 500 disposed on one side of the liquid crystal layer 300 be configured with two or more retardation films, and it is preferable that the total number of retardation films configuring the retardation layer 500 be, for example, two (see FIGS. 7 and 11), three (see FIGS. 8 and 12), four (see FIGS. 9 and 13), or five (see FIGS. 10 and 14). When the retardation layer 500 disposed on one side of the liquid crystal layer 300 is configured with two or more retardation films, the liquid crystal element 10 may include the retardation layer 501 on the other side of the liquid crystal layer 300 (see FIGS. 11 to 14), or may not include the retardation layer 501 on the other side of the liquid crystal layer 300 (see FIGS. 7 to 10).

In the liquid crystal element 10 illustrated in FIGS. 7 and 11, the retardation layer 500 disposed on the side of the second substrate 200 opposite to the liquid crystal layer 300 is configured with two retardation films. In the drawing, retardation films 51a and 52a disposed in this order from the side closer to the liquid crystal layer 300 correspond to the first quarter-wavelength film 1Q, which is a positive A plate, and the second quarter-wavelength film 2Q, which is a positive A plate, respectively. The liquid crystal element 10 illustrated in FIG. 11 further includes the retardation layer 501 on the side of the first substrate 100 opposite to the liquid crystal layer 300, and the retardation layer 501 is preferably a positive C plate.

In the liquid crystal element 10 illustrated in FIGS. 8 and 12, the retardation layer 500 disposed on the side of the second substrate 200 opposite to the liquid crystal layer 300 is configured with three retardation films. Two of these retardation films are quarter-wavelength films and positive A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining one retardation film configuring the retardation layer 500 is preferably a positive C plate.

For the liquid crystal element 10, it is preferable to adopt any of an aspect in which retardation films 51b, 52b, and 53b disposed in this order from the side closer to the liquid crystal layer 300 in FIGS. 8 and 12 are a positive A plate, a positive A plate, and a positive C plate, respectively, an aspect in which the retardation films 51b, 52b, and 53b are a positive A plate, a positive C plate, and a positive A plate, respectively, and an aspect in which the retardation films 51b, 52b, and 53b are a positive C plate, a positive A plate, and a positive A plate, respectively. The liquid crystal element 10 illustrated in FIG. 12 further includes the retardation layer 501 on the side of the first substrate 100 opposite to the liquid crystal layer 300, and the retardation layer 501 is preferably a positive C plate.

In the liquid crystal element 10 illustrated in FIGS. 9 and 13, the retardation layer 500 disposed on the side of the second substrate 200 opposite to the liquid crystal layer 300 is configured with four retardation films. Two of these retardation films are quarter-wavelength films and positive A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining two retardation films configuring the retardation layer 500 are preferably both positive C plates.

For the liquid crystal element 10, it is preferable to adopt any of an aspect in which retardation films 51c, 52c, 53c, and 54c disposed in this order from the side closer to the liquid crystal layer 300 in FIGS. 9 and 13 are a positive A plate, a positive C plate, a positive A plate, and a positive C plate, respectively, an aspect in which the retardation films 51c, 52c, 53c, and 54c are a positive C plate, a positive A plate, a positive A plate, and a positive C plate, respectively, and an aspect in which the retardation films 51c, 52c, 53c, and 54c are a positive C plate, a positive A plate, a positive C plate, and a positive A plate, respectively. The liquid crystal element 10 illustrated in FIG. 13 further includes the retardation layer 501 on the side of the first substrate 100 opposite to the liquid crystal layer 300, and the retardation layer 501 is preferably a positive C plate.

In the liquid crystal element 10 illustrated in FIGS. 10 and 14, the retardation layer 500 disposed on the side of the second substrate 200 opposite to the liquid crystal layer 300 is configured with five retardation films. Two of these retardation films are quarter-wavelength films and positive A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining three retardation films configuring the retardation layer 500 are preferably all positive C plates.

For the liquid crystal element 10, it is preferable to adopt an aspect in which retardation films 51d, 52d, 53d, 54d, and 55d disposed in this order from the side closer to the liquid crystal layer 300 in FIGS. 10 and 14 are a positive C plate, a positive A plate, a positive C plate, a positive A plate, and a positive C plate, respectively. The liquid crystal element 10 illustrated in FIG. 14 further includes the retardation layer 501 on the side of the first substrate 100 opposite to the liquid crystal layer 300, and the retardation layer 501 is preferably a positive C plate.

From the viewpoint of the most excellent switching performance between polarization modulation and polarization non-modulation, it is preferable that the liquid crystal element 10 of the present embodiment be the liquid crystal element 10 illustrated in FIG. 13, the retardation films 51c, 52c, 53c, and 54c in FIG. 13 be a positive C plate, a positive A plate, a positive C plate, and a positive A plate, respectively, and the retardation layer 501 be a positive C plate.

Further, in consideration of the cost, it is preferable to adopt any of an aspect in which the liquid crystal element 10 of the present embodiment be the liquid crystal element 10 illustrated in FIG. 11, the retardation films 51a and 52a in FIG. 11 be both positive A plates, and the retardation layer 501 be a positive C plate, an aspect in which the liquid crystal element 10 is the liquid crystal element 10 illustrated in FIG. 8, and the retardation films 51b, 52b, and 53b in FIG. 8 be a positive A plate, a positive A plate, and a positive C plate, respectively, and an aspect in which the liquid crystal element 10 is the liquid crystal element 10 illustrated in FIG. 12, the retardation films 51b, 52b, and 53b in FIG. 12 be a positive A plate, a positive C plate, and a positive A plate, respectively, and the retardation layer 501 be a positive C plate.

In addition, from the viewpoint of being more suitable for the application in which a PB lens layer is disposed inside (in-cell) the liquid crystal element 10, it is preferable to adopt any of an aspect in which the liquid crystal element 10 of the present embodiment be the liquid crystal element 10 illustrated in FIG. 9 and the retardation films 51c, 52c, 53c, and 54c in FIG. 9 be a positive C plate, a positive A plate, a positive C plate, and a positive A plate, respectively, and an aspect in which the liquid crystal element 10 be the liquid crystal element 10 illustrated in FIG. 9 and the retardation films 51c, 52c, 53c, and 54c in FIG. 9 be a positive C plate, a positive A plate, a positive A plate, and a positive C plate, respectively.

### Other Configurations and the Like

It is preferable that the liquid crystal element 10 further includes a light source. The light source is not particularly limited as long as the light source emits light, and may be a direct type, an edge type, or any other type. For example, the light source preferably includes a light source such as a light emitting diode (LED), a light guide plate, and a reflective sheet, and may further include a diffuser sheet or a prism sheet. For example, the liquid crystal element 10 illustrated in FIG. 1 includes a backlight (not illustrated) on the back surface side of the first substrate 100.

In addition to the above-mentioned members, the liquid crystal element 10 is configured with a plurality of members such as an external circuit such as a tape carrier package (TCP) and a printed wiring board (PCB); an optical film such as a viewing angle expansion film and a brightness enhancement film; and a bezel (frame), and some of such members may be incorporated into another member. Such members are not particularly limited, and those commonly used in the field of liquid crystal elements can be used, and thus the description thereof will be omitted.

### Second Embodiment

In the present embodiment, features unique to the present embodiment will be mainly described, and a description of contents overlapping the first embodiment will be omitted. In the present embodiment, a case will be described in which a liquid crystal element 10 satisfies the above (ii), that is, a case where a first quarter-wavelength film 1Q is a positive A plate, a second quarter-wavelength film 2Q is a negative A plate, and the liquid crystal element 10 further includes a retardation film other than the first quarter-wavelength film 1Q and the second quarter-wavelength film 2Q. Except for this point, the liquid crystal element 10 of the present embodiment is substantially the same as the liquid crystal element 10 of the first embodiment.

FIGS. 8 to 14 are also schematic cross-sectional views illustrating an example of a layer configuration of the liquid crystal element 10 of the present embodiment. As described above, it is preferable that the retardation layer 500 disposed on one side of the liquid crystal layer 300 be configured with two or more retardation films, and it is preferable that the total number of retardation films configuring the retardation layer 500 be, for example, two (see FIGS. 7 and 11), three (see FIGS. 8 and 12), four (see FIGS. 9 and 13), or five (see FIGS. 10 and 14). When the retardation layer 500 disposed on one side of the liquid crystal layer 300 is configured with two retardation films, the liquid crystal element 10 also includes the retardation layer 501 on the other side of the liquid crystal layer 300 (see FIG. 11). In addition, when the retardation layer 500 disposed on one side of the liquid crystal layer 300 is configured with three or more retardation films, the liquid crystal element 10 may include the retardation layer 501 on the other side of the liquid crystal layer 300 (see FIGS. 12 to 14), or may not include the retardation layer 501 on the other side of the liquid crystal layer 300 (see FIGS. 8 to 10).

In the liquid crystal element 10 illustrated in FIG. 11, the retardation layer 500 disposed on the side of the second substrate 200 opposite to the liquid crystal layer 300 is configured with two retardation films. In the drawing, retardation films 51a and 52a disposed in this order from the side closer to the liquid crystal layer 300 correspond to the first quarter-wavelength film 1Q, which is a positive A plate, and the second quarter-wavelength film 2Q, which is a negative A plate, respectively. The liquid crystal element 10 further includes the retardation layer 501 on the side of the first substrate 100 opposite to the liquid crystal layer 300, and the retardation layer 501 is preferably a positive C plate.

In the liquid crystal element 10 illustrated in FIGS. 8 and 12, the retardation layer 500 disposed on the side of the second substrate 200 opposite to the liquid crystal layer 300 is configured with three retardation films. Two of these retardation films correspond to the first quarter-wavelength film 1Q, which is a positive A plate, and the second quarter-wavelength film 2Q, which is a negative A plate. Among these, the positive A plate is located closer to the liquid crystal layer 300. The remaining one retardation film configuring the retardation layer 500 is preferably a positive C plate or a negative C plate. In particular, when the retardation film is disposed on the side of the second quarter-wavelength film 2Q (negative A plate) opposite to the liquid crystal layer 300, the retardation film is preferably a negative C plate. In addition, when a retardation film is disposed on the liquid crystal layer 300 side of the first quarter-wavelength film 1Q (positive A plate), the retardation film is preferably a positive C plate.

The thickness retardation (Rth) of the negative C plate is preferably −300 nm or more and 0 nm or less.

For the liquid crystal element 10, it is preferable to adopt any of an aspect in which the retardation films 51b, 52b, and 53b disposed in this order from the side closer to the liquid crystal layer 300 in FIGS. 8 and 12 are a positive A plate, a negative A plate, and a negative C plate, respectively, an aspect in which the retardation films 51b, 52b, and 53b are a positive A plate, a positive C plate, and a negative A plate, respectively, an aspect in which the retardation films 51b, 52b, and 53b are a positive A plate, a negative C plate, and a negative A plate, respectively, and an aspect in which the retardation films 51b, 52b, and 53b are a positive C plate, a positive A plate, and a negative A plate, respectively. The liquid crystal element 10 illustrated in FIG. 12 further includes the retardation layer 501 on the side of the first substrate 100 opposite to the liquid crystal layer 300, and the retardation layer 501 is preferably a positive C plate.

In the liquid crystal element 10 illustrated in FIGS. 9 and 13, the retardation layer 500 disposed on the side of the second substrate 200 opposite to the liquid crystal layer 300 is configured with four retardation films. Two of these retardation films correspond to the first quarter-wavelength film 1Q, which is a positive A plate, and the second quarter-wavelength film 2Q, which is a negative A plate. Among these, the positive A plate is located closer to the liquid crystal layer 300. The remaining two retardation films configuring the retardation layer 500 are the same as or different from each other, and are preferably positive C plates or negative C plates. In particular, when the retardation film is disposed on the side of the second quarter-wavelength film 2Q (negative A plate) opposite to the liquid crystal layer 300, the retardation film is preferably a negative C plate. In addition, when a retardation film is disposed on the liquid crystal layer 300 side of the first quarter-wavelength film 1Q (positive A plate), the retardation film is preferably a positive C plate.

For the liquid crystal element 10, it is preferable to adopt any of an aspect in which the retardation films 51c, 52c, 53c, and 54c disposed in this order from the side closer to the liquid crystal layer 300 in FIGS. 9 and 13 are a positive A plate, a positive C plate, a negative A plate, and a negative C plate, respectively, an aspect in which the retardation films 51c, 52c, 53c, and 54c are a positive A plate, a negative C plate, a negative A plate, and a negative C plate, respectively, an aspect in which the retardation films 51c, 52c, 53c, and 54c are a positive C plate, a positive A plate, a negative A plate, and a negative C plate, respectively, and an aspect in which the retardation films 51c, 52c, 53c, and 54c are a positive C plate, a positive A plate, a negative C plate, and a negative A plate, respectively, and an aspect in which the retardation films 51c, 52c, 53c, and 54c are a positive C plate, a positive A plate, a positive C plate, and a negative A plate, respectively. The liquid crystal element 10 illustrated in FIG. 13 further includes the retardation layer 501 on the side of the first substrate 100 opposite to the liquid crystal layer 300, and the retardation layer 501 is preferably a positive C plate.

In the liquid crystal element 10 illustrated in FIGS. 10 and 14, the retardation layer 500 disposed on the side of the second substrate 200 opposite to the liquid crystal layer 300 is configured with five retardation films. Two of these retardation films correspond to the first quarter-wavelength film 1Q, which is a positive A plate, and the second quarter-wavelength film 2Q, which is a negative A plate. Among these, the positive A plate is located closer to the liquid crystal layer 300. The remaining three retardation films configuring the retardation layer 500 are the same as or different from each other, and are preferably positive C plates or negative C plates. In particular, when the retardation film is disposed on the side of the second quarter-wavelength film 2Q (negative A plate) opposite to the liquid crystal layer 300, the retardation film is preferably a negative C plate.

For the liquid crystal element 10, it is preferable to adopt any of an aspect in which the retardation films 51d, 52d, 53d, 54d, and 55d disposed in this order from the side closer to the liquid crystal layer 300 in FIGS. 10 and 14 are a positive C plate, a positive A plate, a positive C plate, a negative A plate, and a negative C plate, respectively, and an aspect in which the retardation films 51d, 52d, 53d, 54d, and 55d are a positive C plate, a positive A plate, a negative C plate, a negative A plate, and a negative C plate, respectively. The liquid crystal element 10 illustrated in FIG. 14 further includes the retardation layer 501 on the side of the first substrate 100 opposite to the liquid crystal layer 300, and the retardation layer 501 is preferably a positive C plate.

### Third Embodiment

In the present embodiment, features unique to the present embodiment will be mainly described, and a description of contents overlapping the first embodiment will be omitted. In the present embodiment, a case will be described in which a liquid crystal element 10 satisfies the above (iii), that is, a case where a first quarter-wavelength film 1Q is a negative A plate and a second quarter-wavelength film 2Q is a positive A plate. Except for this point, the liquid crystal element 10 of the present embodiment is substantially the same as the liquid crystal element 10 of the first embodiment.

FIGS. 7 to 14 are also schematic cross-sectional views illustrating an example of a layer configuration of the liquid crystal element 10 of the present embodiment. As described above, it is preferable that the retardation layer 500 disposed on one side of the liquid crystal layer 300 be configured with two or more retardation films, and it is preferable that the total number of retardation films configuring the retardation layer 500 be, for example, two (see FIGS. 7 and 11), three (see FIGS. 8 and 12), four (see FIGS. 9 and 13), or five (see FIGS. 10 and 14). When the retardation layer 500 disposed on one side of the liquid crystal layer 300 is configured with two or more retardation films, the liquid crystal element 10 may include the retardation layer 501 on the other side of the liquid crystal layer 300 (see FIGS. 11 to 14), or may not include the retardation layer 501 on the other side of the liquid crystal layer 300 (see FIGS. 7 to 10).

In the liquid crystal element 10 illustrated in FIGS. 7 and 11, the retardation layer 500 disposed on the side of the second substrate 200 opposite to the liquid crystal layer 300 is configured with two retardation films. In the drawing, retardation films 51a and 52a disposed in this order from the side closer to the liquid crystal layer 300 correspond to the first quarter-wavelength film 1Q, which is a negative A plate, and the second quarter-wavelength film 2Q, which is a positive A plate, respectively. Among these, the negative A plate is located closer to the liquid crystal layer 300. The liquid crystal element 10 illustrated in FIG. 11 further includes the retardation layer 501 on the side of the first substrate 100 opposite to the liquid crystal layer 300, and the retardation layer 501 is preferably a positive C plate.

In the liquid crystal element 10 illustrated in FIGS. 8 and 12, the retardation layer 500 disposed on the side of the second substrate 200 opposite to the liquid crystal layer 300 is configured with three retardation films. Two of these retardation films correspond to the first quarter-wavelength film 1Q, which is a negative A plate, and the second quarter-wavelength film 2Q, which is a positive A plate. Among these, the negative A plate is located closer to the liquid crystal layer 300. The remaining one retardation film configuring the retardation layer 500 is preferably a positive C plate or a negative C plate. In particular, when the retardation film is disposed on the side of the second quarter-wavelength film 2Q (positive A plate) opposite to the liquid crystal layer 300, the retardation film is preferably a positive C plate. In addition, when a retardation film is disposed on the liquid crystal layer 300 side of the first quarter-wavelength film 1Q (negative A plate), the retardation film is preferably a positive C plate or a negative C plate.

For the liquid crystal element 10, it is preferable to adopt any of an aspect in which the retardation films 51b, 52b, and 53b disposed in this order from the side closer to the liquid crystal layer 300 in FIGS. 8 and 12 are a negative A plate, a positive A plate, and a positive C plate, respectively, an aspect in which the retardation films 51b, 52b, and 53b are a negative A plate, a positive C plate, and a positive A plate, respectively, an aspect in which the retardation films 51b, 52b, and 53b are a negative A plate, a negative C plate, and a positive A plate, respectively, an aspect in which the retardation films 51b, 52b, and 53b are a positive C plate, a negative A plate, and a positive A plate, and an aspect in which the retardation films 51b, 52b, and 53b are a negative C plate, a negative A plate, and a positive A plate, respectively. The liquid crystal element 10 illustrated in FIG. 12 further includes the retardation layer 501 on the side of the first substrate 100 opposite to the liquid crystal layer 300, and the retardation layer 501 is preferably a positive C plate.

In the liquid crystal element 10 illustrated in FIGS. 9 and 13, the retardation layer 500 disposed on the side of the second substrate 200 opposite to the liquid crystal layer 300 is configured with four retardation films. Two of these retardation films correspond to the first quarter-wavelength film 1Q, which is a negative A plate, and the second quarter-wavelength film 2Q, which is a positive A plate. Among these, the negative A plate is located closer to the liquid crystal layer 300. The remaining two retardation films configuring the retardation layer 500 are the same as or different from each other, and are preferably positive C plates or negative C plates. In particular, when the retardation film is disposed on the side of the second quarter-wavelength film 2Q (positive A plate) opposite to the liquid crystal layer 300, the retardation film is preferably a positive C plate. In addition, when a retardation film is disposed on the liquid crystal layer 300 side of the first quarter-wavelength film 1Q (negative A plate), the retardation film is preferably a positive C plate or a negative C plate.

For the liquid crystal element 10, it is preferable to adopt any of an aspect in which the retardation films 51c, 52c, 53c, and 54c disposed in this order from the side closer to the liquid crystal layer 300 in FIGS. 9 and 13 are a negative A plate, a positive C plate, a positive A plate, and a positive C plate, respectively, an aspect in which the retardation films 51c, 52c, 53c, and 54c are a negative A plate, a negative C plate, a positive A plate, and a positive C plate, respectively, an aspect in which the retardation films 51c, 52c, 53c, and 54c are a positive C plate, a negative A plate, a positive A plate, and a positive C plate, respectively, an aspect in which the retardation films 51c, 52c, 53c, and 54c are a negative C plate, a negative A plate, a positive A plate, and a positive C plate, respectively, an aspect in which the retardation films 51c, 52c, 53c, and 54c are a positive C plate, a negative A plate, a positive C plate, and a positive A plate, respectively, an aspect in which the retardation films 51c, 52c, 53c, and 54c are a negative C plate, a negative A plate, a positive C plate, and a positive A plate, respectively, an aspect in which the retardation films 51c, 52c, 53c, and 54c are a positive C plate, a negative A plate, a negative C plate, and a positive A plate, respectively, an aspect in which the retardation films 51c, 52c, 53c, and 54c are a negative C plate, a negative A plate, a negative C plate, and a positive A plate, respectively. The liquid crystal element 10 illustrated in FIG. 13 further includes the retardation layer 501 on the side of the first substrate 100 opposite to the liquid crystal layer 300, and the retardation layer 501 is preferably a positive C plate.

In the liquid crystal element 10 illustrated in FIGS. 10 and 14, the retardation layer 500 disposed on the side of the second substrate 200 opposite to the liquid crystal layer 300 is configured with five retardation films. Two of these retardation films correspond to the first quarter-wavelength film 1Q, which is a negative A plate, and the second quarter-wavelength film 2Q, which is a positive A plate. Among these, the negative A plate is located closer to the liquid crystal layer 300. The remaining three retardation films configuring the retardation layer 500 are the same as or different from each other, and are preferably positive C plates or negative C plates. In particular, when the retardation film is disposed on the side of the second quarter-wavelength film 2Q (positive A plate) opposite to the liquid crystal layer 300, the retardation film is preferably a positive C plate. In addition, when a retardation film is disposed on the liquid crystal layer 300 side of the first quarter-wavelength film 1Q (negative A plate), the retardation film is preferably a positive C plate or a negative C plate.

For the liquid crystal element 10, it is preferable to adopt any of an aspect in which the retardation films 51d, 52d, 53d, 54d, and 55d disposed in this order from the side closer to the liquid crystal layer 300 in FIGS. 10 and 14 are a positive C plate, a negative A plate, a positive C plate, a positive A plate, and a positive C plate, respectively, an aspect in which the retardation films 51d, 52d, 53d, 54d, and 55d are a positive C plate, a negative A plate, a negative C plate, a positive A plate, and a positive C plate, respectively, an aspect in which the retardation films 51d, 52d, 53d, 54d, and 55d are a negative C plate, a negative A plate, a positive C plate, a positive A plate, and a positive C plate, respectively, an aspect in which the retardation films 51d, 52d, 53d, 54d, and 55d are a negative C plate, a negative A plate, a negative C plate, a positive A plate, and a positive C plate, respectively. The liquid crystal element 10 illustrated in FIG. 14 further includes the retardation layer 501 on the side of the first substrate 100 opposite to the liquid crystal layer 300, and the retardation layer 501 is preferably a positive C plate.

### Fourth Embodiment

In the present embodiment, features unique to the present embodiment will be mainly described, and a description of contents overlapping the first embodiment will be omitted. In the present embodiment, a case will be described in which a liquid crystal element 10 satisfies the above (iv), that is, a case where both a first quarter-wavelength film 1Q and a second quarter-wavelength film 2Q are negative A plates. Except for this point, the liquid crystal element 10 of the present embodiment is substantially the same as the liquid crystal element 10 of the first embodiment.

FIGS. 7 to 14 are also schematic cross-sectional views specifically illustrating an example of a layer configuration of the liquid crystal element 10 of the present embodiment. As described above, it is preferable that the retardation layer 500 disposed on one side of the liquid crystal layer 300 be configured with two or more retardation films, and it is preferable that the total number of retardation films configuring the retardation layer 500 be, for example, two (see FIGS. 7 and 11), three (see FIGS. 8 and 12), four (see FIGS. 9 and 13), or five (see FIGS. 10 and 14). When the retardation layer 500 disposed on one side of the liquid crystal layer 300 is configured with two or more retardation films, the liquid crystal element 10 may include the retardation layer 501 on the other side of the liquid crystal layer 300 (see FIGS. 11 to 14), or may not include the retardation layer 501 on the other side of the liquid crystal layer 300 (see FIGS. 7 to 10).

In the liquid crystal element 10 illustrated in FIGS. 7 and 11, the retardation layer 500 disposed on the side of the second substrate 200 opposite to the liquid crystal layer 300 is configured with two retardation films. In the drawing, retardation films 51a and 52a disposed in this order from the side closer to the liquid crystal layer 300 correspond to the first quarter-wavelength film 1Q, which is a negative A plate, and the second quarter-wavelength film 2Q, which is a negative A plate, respectively. The liquid crystal element 10 illustrated in FIG. 11 further includes the retardation layer 501 on the side of the first substrate 100 opposite to the liquid crystal layer 300, and the retardation layer 501 is preferably a positive C plate.

In the liquid crystal element 10 illustrated in FIGS. 8 and 12, the retardation layer 500 disposed on the side of the second substrate 200 opposite to the liquid crystal layer 300 is configured with three retardation films. Two of these retardation films are quarter-wavelength films and negative A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining one retardation film configuring the retardation layer 500 is preferably a positive C plate or a negative C plate.

For the liquid crystal element 10, it is preferable to adopt any of an aspect in which the retardation films 51b, 52b, and 53b disposed in this order from the side closer to the liquid crystal layer 300 in FIGS. 8 and 12 are a negative A plate, a negative A plate, and a negative C plate, respectively, an aspect in which the retardation films 51b, 52b, and 53b are a negative A plate, a negative C plate, and a negative A plate, respectively, an aspect in which the retardation films 51b, 52b, and 53b are a positive C plate, a negative A plate, and a negative A plate, respectively, and an aspect in which the retardation films 51b, 52b, and 53b are a negative C plate, a negative A plate, and a negative A plate, respectively. The liquid crystal element 10 illustrated in FIG. 12 further includes the retardation layer 501 on the side of the first substrate 100 opposite to the liquid crystal layer 300, and the retardation layer 501 is preferably a positive C plate.

In the liquid crystal element 10 illustrated in FIGS. 9 and 13, the retardation layer 500 disposed on the side of the second substrate 200 opposite to the liquid crystal layer 300 is configured with four retardation films. Two of these retardation films are quarter-wavelength films and negative A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining two retardation films configuring the retardation layer 500 are preferably both positive C plates.

For the liquid crystal element 10, it is preferable to adopt any of an aspect in which retardation films 51c, 52c, 53c, and 54c disposed in this order from the side closer to the liquid crystal layer 300 in FIGS. 9 and 13 are a negative A plate, a negative C plate, a negative A plate, and a negative C plate, respectively, an aspect in which the retardation films 51c, 52c, 53c, and 54c are a positive C plate, a negative A plate, a negative A plate, and a negative C plate, respectively, an aspect in which the retardation films 51c, 52c, 53c, and 54c are a negative C plate, a negative A plate, a negative A plate, and a negative C plate, respectively, an aspect in which the retardation films 51c, 52c, 53c, and 54c are a positive C plate, a negative A plate, a negative C plate, and a negative A plate, respectively, and an aspect in which the retardation films 51c, 52c, 53c, and 54c are a negative C plate, a negative A plate, a negative C plate, and a negative A plate, respectively. The liquid crystal element 10 illustrated in FIG. 13 further includes the retardation layer 501 on the side of the first substrate 100 opposite to the liquid crystal layer 300, and the retardation layer 501 is preferably a positive C plate.

In the liquid crystal element 10 illustrated in FIGS. 10 and 14, the retardation layer 500 disposed on the side of the second substrate 200 opposite to the liquid crystal layer 300 is configured with five retardation films. Two of these retardation films are quarter-wavelength films and negative A plates. Out of these two retardation films, the retardation film closer to the liquid crystal layer 300 corresponds to the first quarter-wavelength film 1Q, and the retardation film farther from the liquid crystal layer 300 corresponds to the second quarter-wavelength film 2Q. The remaining three retardation films configuring the retardation layer 500 are the same as or different from each other, and are preferably positive C plates or negative C plates.

For the liquid crystal element 10, it is preferable to adopt any of an aspect in which the retardation films 51d, 52d, 53d, 54d, and 55d disposed in this order from the side closer to the liquid crystal layer 300 in FIGS. 10 and 14 are a positive C plate, a negative A plate, a negative C plate, a negative A plate, and a negative C plate, respectively, and an aspect in which the retardation films 51d, 52d, 53d, 54d, and 55d are a negative C plate, a negative A plate, a negative C plate, a negative A plate, and a negative C plate, respectively. The liquid crystal element 10 illustrated in FIG. 14 further includes the retardation layer 501 on the side of the first substrate 100 opposite to the liquid crystal layer 300, and the retardation layer 501 is preferably a positive C plate.

### First Modification Example

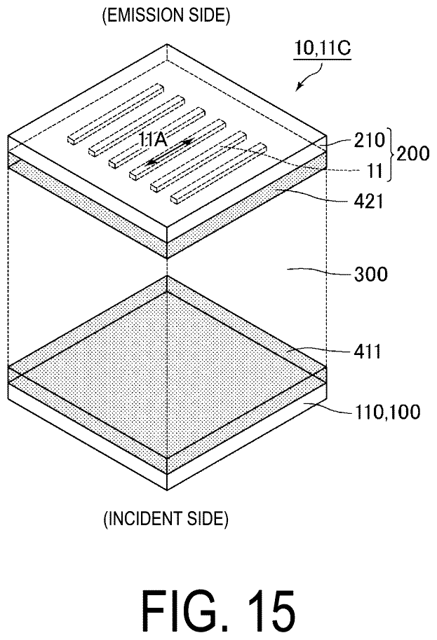

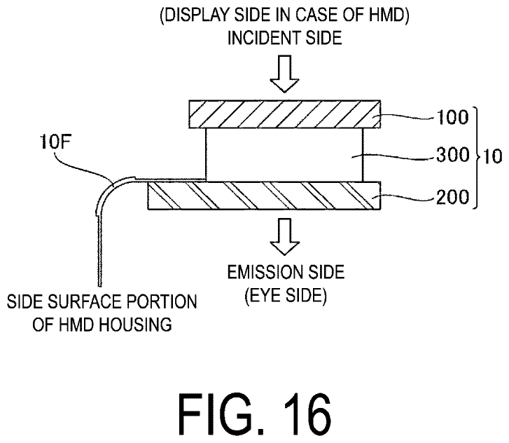

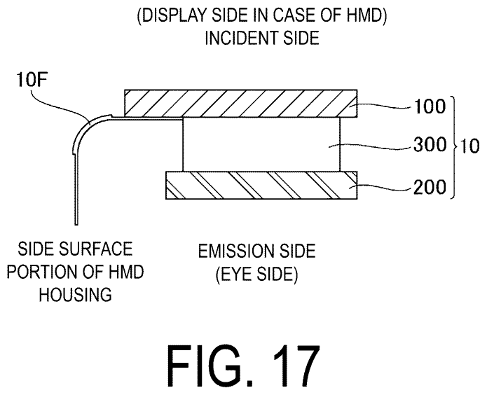

FIG. 15 is a schematic perspective view of a liquid crystal element 10 according to the present modification example. FIG. 16 is a schematic cross-sectional view of the liquid crystal element 10 according to the present modification example. FIG. 17 is a schematic cross-sectional view of a variable focus element including an electrode only on a substrate on an incident side.

In the liquid crystal element 10 according to each of the first to fourth embodiments, the first substrate 100 disposed on the incident side includes the comb-teeth electrode 11, and the second substrate 200 disposed on the emission side does not include a comb-teeth electrode. On the other hand, in the liquid crystal element 10 of the present modification example, as illustrated in FIGS. 15 and 16, the first substrate 100 disposed on the incident side does not include the comb-teeth electrode 11, and the second substrate 200 disposed on the emission side includes the comb-teeth electrode 11. The liquid crystal element 10 according to such an aspect can also improve alignment stability.

As illustrated in FIG. 16, the first substrate 100 or the second substrate 200 of the liquid crystal element 10 according to the present modification example includes a bent flexible printed circuit (FPC) board 10F, and the comb-teeth electrodes 11 are provided only on a substrate located in a bending direction of a flexible printed circuit board 10F out of the first substrate 100 and the second substrate 200.

Here, when the liquid crystal element 10 is driven, as illustrated in FIGS. 16 and 17, the FPC 10F is pressed against the liquid crystal element 10, and a voltage is supplied from an external circuit to drive the liquid crystal element 10. For example, in the case of application to a head-mounted display (HMD) or the like, the FPC 10F needs to be bent to be accommodated in a housing of a headset. In general, since a circuit mechanism is provided in a temple portion of the HMD, the FPC 10F is bent toward an emission side. At this time, when there is an electrode on the incident side, it is necessary to press the FPC 10F against the substrate on the incident side as illustrated in FIG. 17, and the FPC 10F is likely to peel off due to stress at the time of bending. However, the reliability of the device can be improved by providing an electrode substrate on the emission side so that the FPC 10F is bent toward the emission side as in the present modification example having the configuration of FIG. 16.

In this specification, the “bending direction of the FPC” means a direction in which the FPC is bent when the liquid crystal element is viewed in a cross-sectional view.

### Second Modification Example

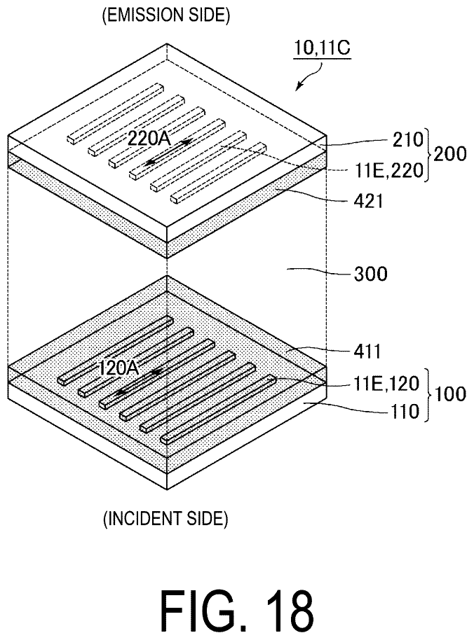

FIG. 18 is a schematic perspective view of a liquid crystal element 10 according to the present modification example. The liquid crystal element 10 of each of the first to fourth embodiments includes the comb-teeth electrode 11 only on one substrate. On the other hand, in the present modification example, as illustrated in FIG. 18, the comb-teeth electrodes 11 include comb-teeth electrodes 120 on the first substrate side provided on the first substrate 100 and comb-teeth electrodes 220 on the second substrate side provided on the second substrate 200, and an extension direction 120A of the comb-teeth electrodes 120 on the first substrate side is parallel to an extension direction 220A of the comb-teeth electrodes 220 on the second substrate side. The liquid crystal element 10 according to such an aspect can also improve alignment stability.

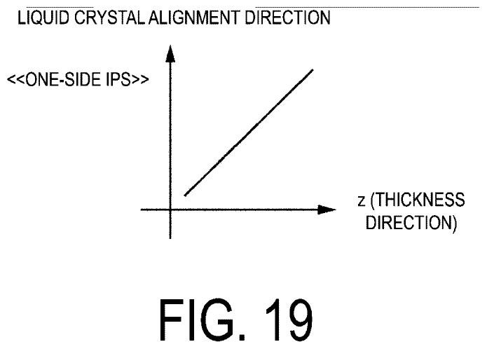

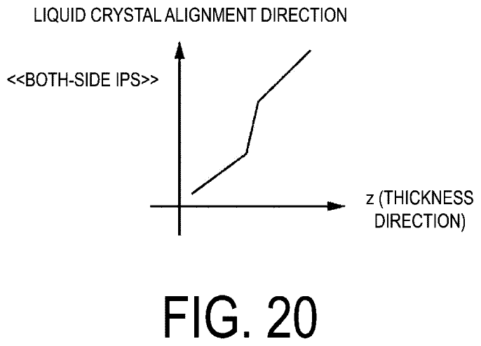

FIG. 19 is a graph conceptually showing a liquid crystal alignment azimuth with respect to the thickness direction of the liquid crystal layer 300 in the liquid crystal element 10 according to the first embodiment. FIG. 20 is a graph conceptually showing a liquid crystal alignment azimuth with respect to the thickness direction of the liquid crystal layer 300 in the liquid crystal element 10 according to the present modification example. As illustrated in FIGS. 19 and 20, in the present modification example having comb-teeth electrodes on both substrates, there may be a portion where a twist change of the dual-frequency drive liquid crystal molecules 310 from the first substrate 100 to the second substrate 200 is weakened as compared with the first embodiment in which the comb-teeth electrodes are provided only on one substrate. When a modulation state is realized by turning off a voltage, the dual-frequency drive liquid crystal molecules are twist-aligned only by a chiral agent added to the dual-frequency drive liquid crystal molecules, and thus the liquid crystal molecules are twisted from the first substrate 100 to the second substrate 200 with a uniform change amount. On the other hand, when a voltage between the first substrate 100 and the second substrate 200 is turned on, there is a region where a twist change becomes gentle once in a bulk portion. In this case, the modulation characteristics of circularly-polarized light can be improved. The alignment direction of the dual-frequency drive liquid crystal molecules in the middle of the bulk may be only a loose twist, or there may be a region in which no twist occurs for a certain period of time.

### Fifth Embodiment

In the present embodiment, features unique to the present embodiment will be mainly described, and a description of contents overlapping the first to fourth embodiments and the first and second modification examples will be omitted. In the present embodiment, a variable focus element 30 including the liquid crystal element 10 will be described. The liquid crystal element 10 is, for example, the liquid crystal element 10 of any one of the first to fourth embodiments and the first and second modification examples.

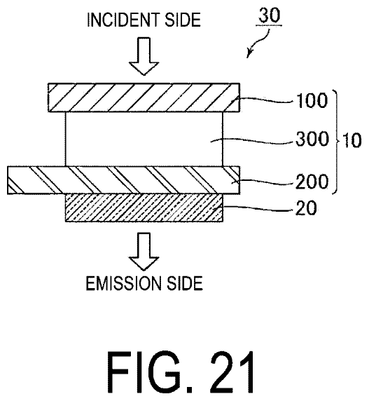

FIG. 21 is a schematic cross-sectional view of the variable focus element 30 according to the present embodiment. As illustrated in FIG. 21, the variable focus element 30 includes the liquid crystal element 10 and a Pancharatnam-berry (also abbreviated as PB) lens layer 20 disposed outside the liquid crystal element 10. The liquid crystal element 10 can modulate circularly-polarized light as described above.

Since the PB lens layer 20 has different focal lengths for right handed circularly-polarized light and left handed circularly-polarized light, the variable focus element 30 that is focus-variable in a wide band can be implemented by combining the liquid crystal element 10 and the PB lens layer 20.

The PB lens layer 20 has a function of condensing and diverging circularly-polarized light. The PB lens layer 20 can be manufactured by, for example, a method disclosed in WO 2019/189818.

### Third Modification Example

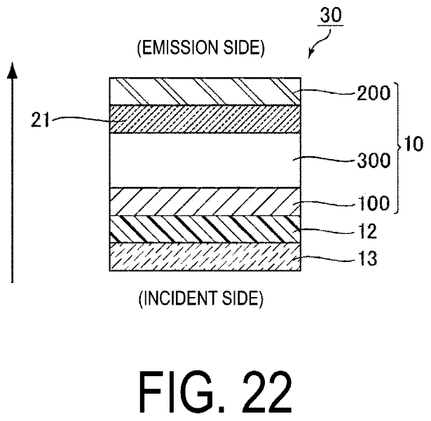

FIG. 22 is a schematic cross-sectional view of a variable focus element according to the present modification example. The PB lens layer 20 of the fifth embodiment is disposed outside the liquid crystal element 10 (that is, out-cell). On the other hand, as illustrated in FIG. 22, the variable focus element 30 of the present modification example includes the liquid crystal element 10 and the PB lens layer 21 disposed inside the liquid crystal element 10. The variable focus element 30 is focus-variable in a wide band.

In other words, the PB lens layer 21 formed as an in-cell lens is an in-cell retardation layer that is patterned so that a slow axis direction rotates in the plane. The PB lens layer 21 can be formed as an in-cell lens by, for example, applying a photosensitive material for forming an in-cell PB lens containing a polymer on the second substrate 200 to form a film for forming a PB lens, and then performing alignment processing on the film for forming a PB lens.

### Sixth Embodiment

In the present embodiment, features unique to the present embodiment will be mainly described, and a description of contents overlapping the first to fifth embodiments and the first to third modification examples will be omitted. In the present embodiment, a head-mounted display 1 including the liquid crystal element 10 will be described. The liquid crystal element 10 is, for example, the liquid crystal element 10 of any one of the first to fifth embodiments and the first to third modification examples.

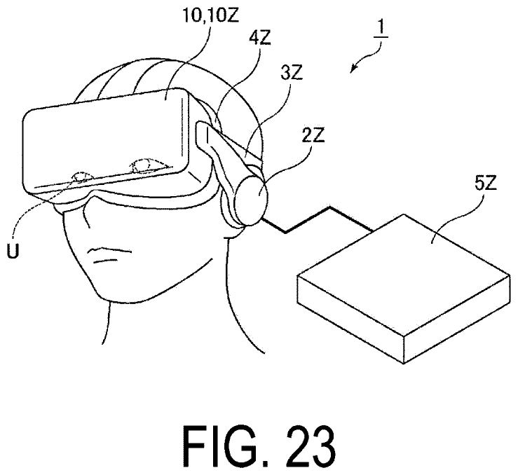

FIG. 23 is a schematic diagram illustrating an example of the head-mounted display 1 according to the present embodiment. As illustrated in FIG. 23, the head-mounted display 1 includes the liquid crystal element 10. The head-mounted display 1 is a display device that can be mounted on the head of a user U, and is a binocular and immersive display that completely covers the eyes of the user in a state of being mounted on the head.

The head-mounted display 1 has a function of displaying a video to the user U, and includes a video output unit 10Z including the liquid crystal element 10, an audio output unit 2Z having a function of generating audio such as sounds, music, and sound effects, a mounting unit 3Z that integrally connects the video output unit 10Z and the audio output unit 2Z and detachably mounts the video output unit 10Z and the audio output unit 2Z on the head of the user U, and a face cushion 4Z disposed between the video output unit 10Z and the face of the user U. The video output unit 10Z is configured with one display.

In addition, the head-mounted display 1 includes a drive unit 5Z that outputs a video display signal and an audio output signal, and the drive unit 5Z is connected to the video output unit 10Z and the audio output unit 2Z in a wired or wireless manner. Examples of a wireless communication method include Bluetooth (trade name).

The effects of the disclosure will be described below with reference to examples and comparative examples, but the disclosure is not limited by these examples.

### Test Example 1

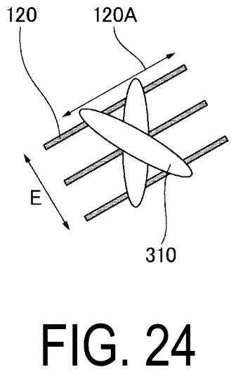

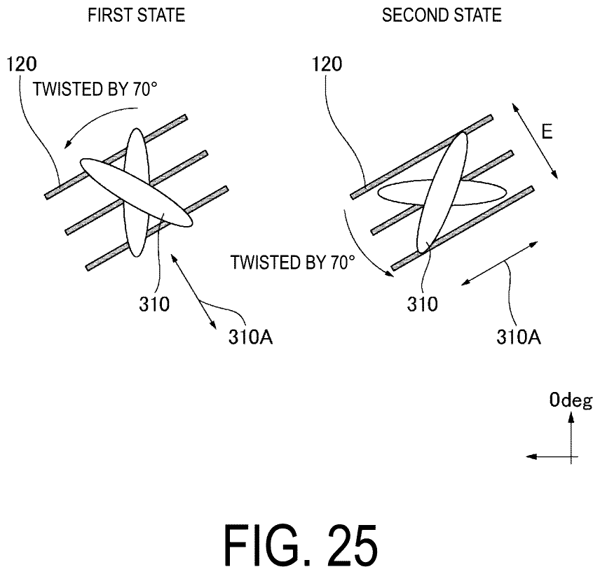

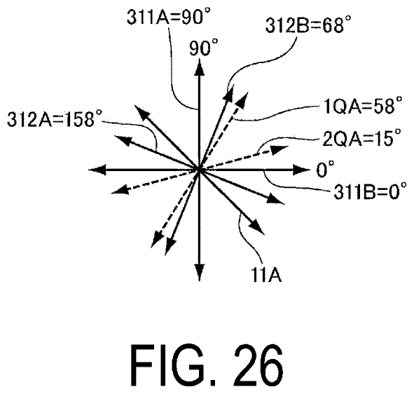

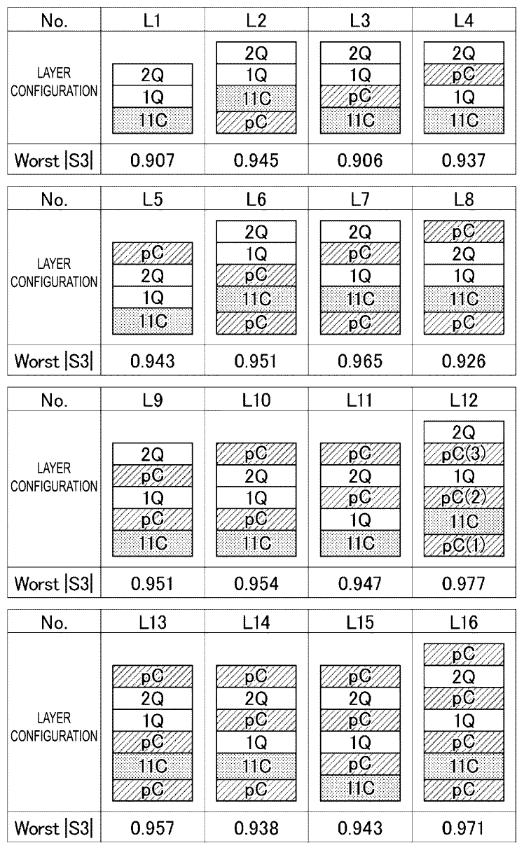

Liquid crystal elements 10 of the present test example corresponding to the liquid crystal element 10 of the first embodiment were manufactured as follows (see FIGS. 24 to 27). FIG. 24 is a schematic diagram illustrating the alignment of liquid crystal molecules when the liquid crystal cell included in the liquid crystal element 10 according to the present test example is heated to an isotropic phase state and then rapidly cooled. FIG. 25 is a schematic diagram illustrating the alignment of liquid crystal molecules in the first state and the second state of the liquid crystal element 10 according to the present test example. FIG. 26 is a diagram illustrating the axial orientation of the liquid crystal element 10 according to the present test example. FIG. 27 illustrates layer configurations of liquid crystal elements L1 to L16 manufactured in this example.

First, the first substrate 100 including the comb-teeth electrode 11 in which a comb-shaped pixel electrode and a comb-shaped common electrode are provided such that comb teeth of the pixel electrode and the comb teeth of the common electrode are fitted to each other, and the second substrate 200 including a photospacer and no electrode were prepared. An electrode width of the comb-teeth electrode 120 was 3 μm, and a slit width (also referred to as a space) was 9 μm. The azimuth angle of the comb-teeth electrode 11 in the extension direction 11A was set to 1250.

Next, a weak anchoring horizontal alignment film, which is configured such that an alignment regulating force was reduced as far as possible, was formed on both the first substrate 100 and the second substrate 200. That is, the first weak anchoring horizontal alignment film 411 was formed on the first substrate 100, and the second weak anchoring horizontal alignment film 421 was formed on the second substrate 200. The first weak anchoring horizontal alignment film 411 and the second weak anchoring horizontal alignment film 421 were not subjected to photo-alignment processing or rubbing treatment, and the first weak anchoring horizontal alignment film 411 and the second weak anchoring horizontal alignment film 421 did not have a uniaxial alignment property. That is, the first weak anchoring horizontal alignment film 411 and the second weak anchoring horizontal alignment film 421 had small in-plane anisotropy. In-plane retardations of the first weak anchoring horizontal alignment film 411 and the second weak anchoring horizontal alignment film 421 were 0.8 nm. The azimuthal anchoring energy of the first weak anchoring horizontal alignment film 411 was 5×10⁻⁶ J/m², and the azimuthal anchoring energy of the second weak anchoring horizontal alignment film 421 was 5×10⁻⁶ J/m². In the present test example, a weak anchoring film (which returns to the initial alignment in a voltage-off state) of a type applied onto a substrate was used as in the case of a normal alignment film. The first weak anchoring horizontal alignment film 411 and the second weak anchoring horizontal alignment film 421 were each formed of one type of polymer.

Subsequently, a sealing material was drawn on the second substrate 200, and the first substrate 100 and the second substrate 200 were bonded together with a liquid crystal material (the liquid crystal layer 300 containing the dual-frequency drive liquid crystal molecules 310) interposed therebetween, thereby manufacturing the liquid crystal cell 11C. Here, as the liquid crystal material, a material obtained by adding a chiral agent to dual-frequency drive liquid crystal molecules was used. The concentration of the chiral agent was adjusted such that the twist angle between the upper and lower substrates in the liquid crystal cell was 70°.

In a liquid crystal element in which the alignment films on both sides (that is, the first weak anchoring horizontal alignment film 411 and the second weak anchoring horizontal alignment film 421) are weak anchoring alignment films, alignment defects may occur in a normal liquid crystal production process. Consequently, in the present test example, the liquid crystal cell 11C was heated to an isotropic phase state, and then the temperature was lowered while applying a voltage to the comb-teeth electrodes 11 of the first substrate 100, thereby obtaining the liquid crystal element 10 without alignment defects. The voltage applied at this time was less than a crossover frequency of the dual-frequency drive liquid crystal (specifically, 30 Hz, 5 V, and the sign of as of the liquid crystal molecules was positive). As a result of this processing, as illustrated in FIG. 24, an average liquid crystal alignment direction of the dual-frequency drive liquid crystal molecules 310 in a voltage-off state was uniformly aligned in a state of being perpendicular to the extension direction 11A of the comb-teeth electrodes 11. Note that the average liquid crystal alignment direction was measured by Axoscan as described above.

A quarter-wavelength film 1Q (first quarter-wavelength film 1Q) having flat chromatic dispersion, a quarter-wavelength film 2Q (second quarter-wavelength film 2Q) having flat chromatic dispersion, and one or a plurality of positive C plates (sign pC) as necessary were attached to the liquid crystal cell 11C obtained above so as to have the layer configuration illustrated in FIG. 27, thereby manufacturing the liquid crystal elements L1 to L16.

In the present test example, as illustrated in FIG. 26, in a plan view, the azimuth in the alignment direction 311A of the dual-frequency drive liquid crystal molecules 311 on the first substrate 100 side in the first state is 90°, the azimuth in the alignment direction 312A of the dual-frequency drive liquid crystal molecules 312 on the second substrate 200 side in the first state is 158°, the azimuth in the alignment direction 311B of the dual-frequency drive liquid crystal molecules 311 on the first substrate 100 side in the second state is 0°, the azimuth in the alignment direction 312B of the dual-frequency drive liquid crystal molecules 312 on the second substrate 200 side in the second state is 68°, the slow axis 1QA of the first quarter-wavelength film 1Q is 58°, and the slow axis 2QA of the second quarter-wavelength film 2Q is 15°.

In each of the liquid crystal elements illustrated in FIG. 27, a backlight (not illustrated) is disposed on the lower side in the drawing. For example, in FIG. 27, the liquid crystal element L2 includes a positive C plate pC on the light incident side of the liquid crystal cell 11C (that is, the side of the first substrate 100 opposite to the liquid crystal layer 300), and includes the first quarter-wavelength film 1Q and the second quarter-wavelength film 2Q in this order from the side closer to the liquid crystal cell 11C on the light emission side of the liquid crystal cell 11C (that is, the side of the second substrate 200 opposite to the liquid crystal layer 300). In addition, three positive C plates pC included in the liquid crystal element L12 are distinguished from each other by signs pC(1), pC(2), and pC(3) for the sake of convenience. That is, the liquid crystal element L12 includes the positive C plate pC(1) on the light incident side of the liquid crystal cell 11C, and includes the positive C plate pC(2), the first quarter-wavelength film 1Q, the positive C plate pC(3), and the second quarter-wavelength film 2Q in this order from the side closer to the liquid crystal cell 11C on the light emission side of the liquid crystal cell 11C.

The quarter-wavelength films and the positive C plates used are as follows. The first quarter-wavelength film 1Q was a positive A plate, and the azimuth angle of the slow axis 1QA was 58°. The quarter-wavelength film 1Q also had Re(450)/Re(550)=1.01, and Re(650)/Re(550)=0.99. The second quarter-wavelength film 2Q was a positive A plate, and the azimuth angle of the slow axis 2QA was 15°. The quarter-wavelength film 2Q also had Re(450)/Re(550)=1.01, and Re(650)/Re(550)=0.99. The positive C plate pC had Rth=75 nm, Re(450)/Re(550)=1.07, and Re(650)/Re(550)=0.97 at a wavelength of 550 nm.

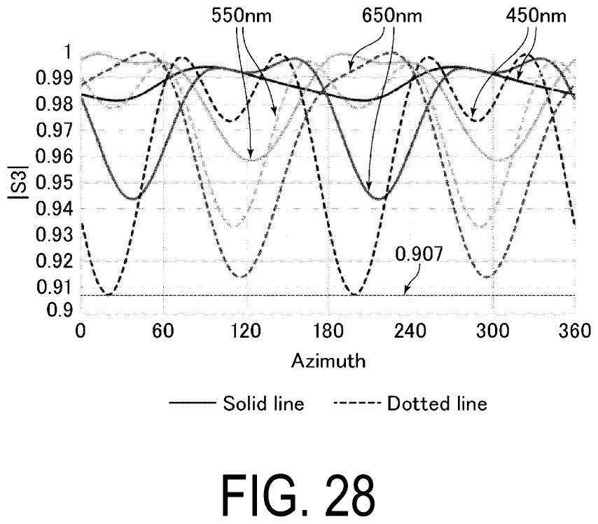

The liquid crystal element L1 (see FIG. 27) that does not include a positive C plate was evaluated for S3 characteristics (that is, modulation characteristics at three visible wavelengths of 450 nm, 550 nm, and 650 nm) with respect to the azimuth angle at a polar angle of 30° by using Axoscan manufactured by Axometrics, Inc. The results are shown in FIG. 28. FIG. 28 is a graph showing evaluation results of S3 characteristics of the liquid crystal element L1 with respect to the azimuth angle at a polar angle of 30°. In FIG. 28, a solid line represents a value assumed when a low-frequency voltage is applied to the comb-teeth electrodes (that is, a value assumed in a modulation state). A dotted line represents a value assumed when a high-frequency voltage is applied to the comb-teeth electrodes (that is, a value assumed in a non-modulation state).

As shown in FIG. 28, the worst value (referred to as “Worst |S3|”) of absolute values of the stokes parameters S3 among all conditions was 0.907. In this evaluation, light of S3=+1 is incident on the liquid crystal element, and it can be said that an excellent modulation state is set when emitted light is close to S3=−1, and an excellent non-modulation state is set when the emitted light is close to S3=+1. Thus, the closer the Worst |S3| is to 1, the better the modulation characteristics.

Similarly, S3 characteristics of each of the liquid crystal elements L2 to L16 with respect to the azimuth angle at a polar angle of 30° were evaluated using Axoscan manufactured by Axometrics, Inc. The Worst |S3| for each of the liquid crystal elements is illustrated in FIG. 27. FIG. 27 is a diagram illustrating each layer configuration and each Worst |S3| of the liquid crystal element 10 (that is, the liquid crystal elements L1 to L16) obtained in Test Example 1.

From FIG. 27, it was found that the liquid crystal element L12 had the best performance among the liquid crystal elements 10 obtained in the present test example. When cost is considered important as well as performance, the liquid crystal elements L2, L5, and L7 are also considered to be suitable. Further, assuming that the PB lens layer is disposed inside the liquid crystal element 10 (in-cell), the liquid crystal element L9 and the liquid crystal element L10 are considered to be suitable because a sufficient effect cannot be obtained even when a retardation film is disposed on both sides of the liquid crystal cell 11C.

In the liquid crystal element 10 of the present test example, a relationship between the components was as illustrated in the first state in FIG. 25 when no voltage was applied or when the liquid crystal element 10 was driven at a frequency lower than the crossover frequency of the dual-frequency drive liquid crystal (also referred to as “low-frequency driving”). At this time, the incident circularly-polarized light became the opposite circularly-polarized light and was emitted (modulation state). On the other hand, when the liquid crystal element 10 was driven at a frequency equal to or higher than the crossover frequency (for example, 300 kHz) of the dual-frequency drive liquid crystals (also referred to as high-frequency driving), a relationship between the components was as illustrated in the second state in FIG. 25. At this time, the incident circularly-polarized light was emitted while maintaining the orientation of the circularly-polarized light (non-modulation state). Further, when the state was changed from the high-frequency driving to the voltage-off state or the low-frequency driving, the state was returned to the modulation state. In this manner, a device capable of switching circularly-polarized light by changing the driving frequency of the liquid crystal molecules or the application/non-application of a voltage was obtained.

### Test Example 2

In Test Example 1, for the liquid crystal element L12 (see FIG. 27) having the best S3 characteristics, S3 characteristics were evaluated in the same manner as described above by changing a retardation (Δnd) and an azimuth angle of a slow axis of each film and parameters of the liquid crystal layer 300. Tables 1 and 2 show physical property values when Worst |S3| is less than 0.9. Unless otherwise specified, regarding an azimuth, when the liquid crystal element 10 is viewed in a plan view from a light emission side, the 3 o'clock direction of the clock is set as a reference (0°), the counterclockwise direction from the reference azimuth is set as a positive (+) angle, and the clockwise direction from the reference azimuth is set as a negative (−) angle (see FIG. 29). FIG. 29 is a conceptual diagram illustrating the setting of an azimuth.

TABLE 1

| Liquid crystal | | | Liquid crystal | | |
|---|---|---|---|---|---|
| parameter in | | | parameter in | | |
| second state | | | first state | | |
| | | Liquid crystal | | | Liquid crystal |
| | | azimuth | | | azimuth |
| | Twist | (degrees) on | | Twist | (degrees) on |
| Δnd | angle | first | Δnd | angle | first |
| (nm) | (degrees) | substrate side | (nm) | (degrees) | substrate side |
| 181 | 57 | −10 | 188 | 59 | 80 |
| 268 | 80 | 9 | 268 | 79 | 99 |

TABLE 2

| Quarter-wavelength films Q1 and Q2 | | | | Positive C plates pC(1), | | |
|---|---|---|---|---|---|---|
| Q1 | | Q2 | | pC(2), and pC(3) | | |
| | Slow | | Slow | pC1 | pC2 | pC3 |
| Δnd | axis | Δnd | axis | Δnd | Δnd | Δnd |
| (nm) | (degrees) | (nm) | (degrees) | (nm) | (nm) | (nm) |
| 110 | 5 | 50 | 6 | 0 | 0 | 0 |
| 165 | 24 | 200 | 19 | 294 | 310 | 371 |

In Table 1, Δnd is a product of a birefringence Δn of the dual-frequency drive liquid crystal molecules 310 included in the liquid crystal layer 300 and a thickness d (μm) of the liquid crystal layer 300. As described above, the twist angle (degrees) is an angle formed by the alignment direction 311A of the dual-frequency drive liquid crystal molecules 311 on the first substrate 100 side and the alignment direction 312B of the dual-frequency drive liquid crystal molecules 312 on the second substrate 200 side in a plan view. The liquid crystal azimuth (degrees) on the first substrate side is the alignment direction 311A of the dual-frequency drive liquid crystal molecules 311 on the first substrate 100 side. In Table 2, Δnd of each retardation film is a product of a birefringence Δn of the retardation film and a thickness d (μm) of the retardation film.

In Table 2, Δnd (nm) of the positive C plate is a thickness retardation (Rth) of the positive C plate.

Referring to Table 1, for example, liquid crystal parameters in a second state (polarization non-modulation state) are described. When Δnd is 181 nm or less and 268 nm or more, Worst |S3| is less than 0.9 (see Table 1). When the twist angle of the liquid crystal molecules was 57° or less and 80° or more, and when the liquid crystal azimuth on the first substrate side was −10° or less and 9° or more, the Worst |S3| was less than 0.9 (see Table 1). Thus, it was found that, in the second state (polarization non-modulation state), Δnd of the liquid crystal layer 300 is preferably 181 nm or more and 268 nm or less, the twist angle of the liquid crystal molecules is preferably 57° or more and 80° or less, and the liquid crystal azimuth on the first substrate side is preferably −10° or more and 9° or less. Similarly, it was found that, in the first state (polarization modulation state), Δnd of the liquid crystal layer 300 is preferably 188 nm or more and 268 nm or less, the twist angle of the liquid crystal molecules is preferably 59° or more and 79° or less, and the liquid crystal azimuth on the first substrate side is preferably 80° or more and 99° or less.

Similarly, it was found from Table 2 that, in the first quarter-wavelength film 1Q, Δnd is preferably 110 nm or more and 165 nm or less, and a slow axis 1QA is preferably 5° or more and 24° or less. It was found that, in the second quarter-wavelength film 2Q, Δnd is preferably 50 nm or more and 200 nm or less and a slow axis 2QA is preferably 6° or more and 19° or less. It was found that, in the positive C plate, Δnd is preferably 0 nm or more and 371 nm or less. In particular, it was found that, in the positive C plate pC(1) disposed on the light incident side of the liquid crystal cell 11C, Δnd is preferably 0 nm or more and 294 nm or less.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A liquid crystal element comprising:
a first substrate, a first weak anchoring horizontal alignment film, a liquid crystal layer containing dual-frequency drive liquid crystal molecules, a second weak anchoring horizontal alignment film, and a second substrate in this order,
wherein the liquid crystal element further includes a retardation layer on at least one of a side of the first substrate opposite to the liquid crystal layer or a side of the second substrate opposite to the liquid crystal layer,
a comb-teeth electrode configured to generate an electric field for the liquid crystal layer is provided on at least one of the first substrate or the second substrate,
the dual-frequency drive liquid crystal molecules are twist-aligned between the first substrate and the second substrate in a voltage applied state and a voltage non-applied state, and a twist direction in the voltage applied state is identical to a twist direction in the voltage non-applied state,
an alignment direction of dual-frequency drive liquid crystal molecules located at a center of the liquid crystal layer in a thickness direction is perpendicular or parallel to an extension direction of the comb-teeth electrode,
the retardation layer includes a first quarter-wavelength film and a second quarter-wavelength film in this order from a side closer to the liquid crystal layer, and
at least one of the first quarter-wavelength film or the second quarter-wavelength film is a positive A plate or a negative A plate.

2. The liquid crystal element according to claim 1,
wherein any one of (i) to (iv) described below is satisfied:
(i) the first quarter-wavelength film and the second quarter-wavelength film are positive A plates;
(ii) the first quarter-wavelength film is a positive A plate, the second quarter-wavelength film is a negative A plate, and the liquid crystal element further includes a retardation film other than the first quarter-wavelength film and the second quarter-wavelength film;
(iii) the first quarter-wavelength film is a negative A plate, and the second quarter-wavelength film is a positive A plate; and
(iv) the first quarter-wavelength film and the second quarter-wavelength film are negative A plates.

3. The liquid crystal element according to claim 1,
wherein the first quarter-wavelength film and the second quarter-wavelength film are disposed on a side of the second substrate opposite to the liquid crystal layer.

4. The liquid crystal element according to claim 3, comprising:
a positive C plate on a side of the first substrate opposite to the liquid crystal layer.

5. The liquid crystal element according to claim 1,
wherein the first weak anchoring horizontal alignment film has an azimuthal anchoring energy of less than 1×10⁻⁴ J/m².

6. The liquid crystal element according to claim 1,
wherein the first weak anchoring horizontal alignment film contains a polymer including at least one group of a group represented by the following structural formula (P1) or a group represented by the following structural formula (P2): 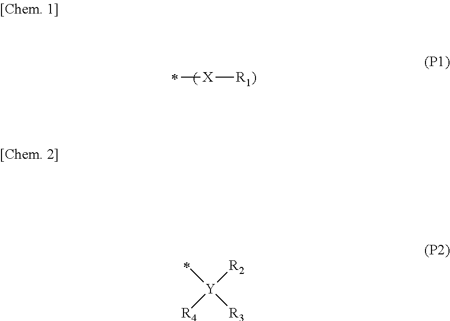
in the above structural formulae, X represents at least one group of an ether group, an ester group, or an amide group; R₁, R₂, R₃, and R₄ each independently represent a hydrocarbon group; and Y represents a carbon atom or a silicon atom.

7. The liquid crystal element according to claim 1,
wherein the second weak anchoring horizontal alignment film has an azimuthal anchoring energy of less than 1×10⁻⁴ J/m².

8. The liquid crystal element according to claim 1,
wherein the second weak anchoring horizontal alignment film contains a polymer including at least one group of a group represented by the following structural formula (P1) or a group represented by the following structural formula (P2): 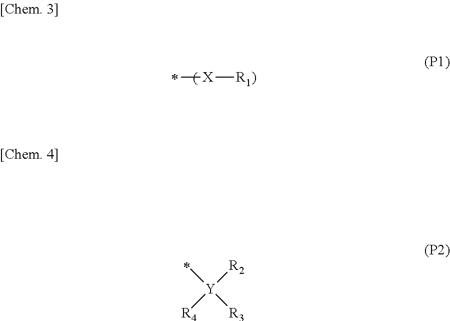
in the above structural formulae, X represents at least one group of an ether group, an ester group, or an amide group; R₁, R₂, R₃, and R₄ each independently represent a hydrocarbon group; and Y represents a carbon atom or a silicon atom.

9. The liquid crystal element according to claim 1,
wherein the first weak anchoring horizontal alignment film and the second weak anchoring horizontal alignment film do not have a uniaxial orientation.

10. The liquid crystal element according to claim 1,
wherein the first weak anchoring horizontal alignment film and the second weak anchoring horizontal alignment film each have an in-plane retardation of less than 1 nm.

11. The liquid crystal element according to claim 1,
wherein in the voltage non-applied state, the alignment direction of the dual-frequency drive liquid crystal molecules located at the center of the liquid crystal layer in the thickness direction is perpendicular to the extension direction of the comb-teeth electrode.

12. The liquid crystal element according to claim 1,
wherein the comb-teeth electrode is provided on only one of the first substrate and the second substrate.

13. The liquid crystal element according to claim 1,
wherein the comb-teeth electrode includes a first substrate side comb-teeth electrode provided on the first substrate and a second substrate side comb-teeth electrode provided on the second substrate, and
an extension direction of the first substrate side comb-teeth electrode is parallel to an extension direction of the second substrate side comb-teeth electrode.

14. The liquid crystal element according to claim 1,
wherein a ratio of an electrode width to a slit width of the comb-teeth electrode (electrode width:slit width) is from 1:2 to 1:6.

15. The liquid crystal element according to claim 1,
wherein a ratio of a thickness of the liquid crystal layer to a slit width of the comb-teeth electrode (thickness of liquid crystal layer:slit width) is from 1:2.5 to 1:10.

16. The liquid crystal element according to claim 1,
wherein at least one horizontal alignment film out of the first weak anchoring horizontal alignment film and the second weak anchoring horizontal alignment film is in contact with the comb-teeth electrode and contains at least two types of polymers having mutually different refractive indices, and
a polymer having a smallest refractive index out of the at least two types of polymers is in contact with the liquid crystal layer.

17. The liquid crystal element according to claim 1,
wherein a ratio of an azimuthal anchoring energy of the second weak anchoring horizontal alignment film to an azimuthal anchoring energy of the first weak anchoring horizontal alignment film is 10 or less.

18. The liquid crystal element according to claim 1,
wherein the first substrate or the second substrate further includes a flexible printed circuit board having a curved shape, and
the comb-teeth electrode is provided only on a substrate, out of the first substrate and the second substrate, located in a curving direction of the flexible printed circuit board.

19. A head-mounted display comprising:
the liquid crystal element according to claim 1.
